(19) United States
(12) Patent Application Publication
(10) Pub. No.: US 2025/0203428 A1
(43) Pub. Date: Jun. 19, 2025

(54) MEASURING AND/OR REPORTING FOR SUBSET OF REFERENCE SIGNAL (RS) PORTS

(71) Applicant: Telefonaktiebolaget LM Ericsson (publ), Stockholm (SE)

(72) Inventors: Rui FAN, Beijing (CN); Sina MALEKI, Malmö (SE); Ilmiawan SHUBHI, Malmö (SE); Ali NADER, Malmö (SE); Andres REIAL, Höllviken (SE); Huaisong ZHU, Beijing (CN)

(21) Appl. No.: 18/845,064

(22) PCT Filed: Mar. 30, 2023
(86) PCT No.: PCT/CN2023/085069

§ 371 Date: Sep. 9, 2024

(30) Foreign Application Priority Data
Mar. 31, 2022 (WO) PCT/CN2022/084538

(51) Int. Cl. H04W 24/10; H04B 7/06; H04L 5/00; H04W 72/231

(52) U.S. Cl. CPC H04W 24/10; H04B 7/0626; H04L 5/0051; H04W 72/231

(57) ABSTRACT

The present disclosure is related to a UE, a network node, and methods for measuring and/or reporting for one or more subsets of RS ports. A method at a UE for reporting a measurement for one or more RS ports includes: determining a first number of subsets of RS ports, each of the subsets belonging to a set of one or more RS ports associated with a same RS configuration; receiving, from a network node, one or more messages indicating one or more first subsets of RS ports from the first number of subsets of RS ports; measuring the one or more first subsets of RS ports; and transmitting, to the network node, a report message indicating a measurement for the one or more first subsets of RS ports.

### CROSS-REFERENCE TO RELATED APPLICATION(S)

This application claims priority to the PCT International Application No. PCT/CN2022/084538, entitled “MEASURING AND/OR REPORTING FOR SUBSET OF REFERENCE SIGNAL (RS) PORTS”, filed on Mar. 31, 2022, which is incorporated herein by reference in its entirety.

### TECHNICAL FIELD

The present disclosure is related to the field of telecommunication, and in particular, to a user equipment (UE), a network node, and methods for measuring and/or reporting for one or more subsets of reference signals (RS) ports.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly power-efficient Radio Access Network (RAN), such as a fifth generation (5G) New Radio (NR) RAN, will be required.

The network (NW) power consumption for 5G NR is said to be less compared to Long Term Evolution (LTE) because of its lean design. In the current implementation, however, NR will most likely consume more power compared to LTE, e.g., due to the higher bandwidth, and more so due to introduction of additional elements such as 64 TX/RX ports with associated digital Radio Frequency (RF) chains. As the NW is expected to be able to support UEs with its maximum capability (e.g., throughput, coverage, etc.), the NW may need to use full configuration even when the maximum NW support is actually rarely needed by the UEs.

In addition, an increased number of TX/RX ports also leads to an increase to the number of reference signals (e.g., Channel State Information Reference Signal or CSI-RS) needed to be transmitted by the NW (and to be measured by the UEs) for a proper signal detection. Thus, the additional TX/RX ports may result in another additional power consumption, i.e., to transmit a larger number of CSI-RSs to the UEs. Furthermore, it should also be noted that the larger number of CSI-RS transmissions may also consume the valuable NW resources.

### SUMMARY

By configuring UE with multiple CSI-RS configurations that can be activated/deactivated or switched, NW may have flexibility on which CSI-RS should be used at one time instance. For example, the following mechanism can be used by the NW to exploit the multiple CSI-RS configurations.
1. Configuring the UE with multiple CSI-RS configurations.
2. Indicating the UE to switch from the first CSI-RS configuration to the second CSI-RS configuration.
3. After sending the switching indication, the NW may then transmit the CSI-RS according to the second CSI-RS configuration.

On the UE side, the UE may receive a first CSI-RS configuration and a second CSI-RS configuration. The UE then may start measuring or report based on the first configuration as the default one, and at one time instant, the UE may receive a Medium Access Control (MAC) Control Element (CE) command or a Downlink Control Information (DCI) indicating that the UE should perform measurements or reporting based on the second configuration, and thus the UE measures the CSI-RS based on the second configuration or report CSI based on measuring the second CSI-RS configuration.

In some embodiments, a group of UEs may receive command to switch to a second configuration. This may for example be implemented as a group MAC or a DCI using group common search space. Then a group of UEs can be configured to, using low signaling overhead and low latency, switch CSI-RS configurations. The individual CSI-RS configurations may still be configured per-UE. The group switching command can be for example be formulated as:
all UEs in group switch to specific configuration index, for example, switch to nzp-CSI-RS-ResourcesDefault or nzp-CSI-RS-ResourcesB.
all UEs in group switch to an implicitly indicated configuration, for example, switch to CSI-RS configuration with shortest periodicity, densest allocation in time/frequency, largest number of ports, etc.

However, there are still some problems with the embodiments described above. For example, it requires to configure UE with multiple CSI-RS resources so that UE can measure a different number or sets of CSI-RS ports. This will consume many resources when multiple CSI-RS ports combination needs to be measured. Furthermore, when using MAC CE or DCI to indicate to UE which CSI-RS resource to measure, it is associated with actual antenna muting. Since it takes time for hardware to turn on and off, the overhead of this solution is also high.

Therefore, to address or at least partially alleviate the above issues, some embodiments of the present disclosure are provided.

According to a first aspect of the present disclosure, a method at a UE for reporting a measurement for one or more reference signal (RS) ports is provided. The method comprises: determining a first number of subsets of RS ports, each of the subsets belonging to a set of one or more RS ports associated with a same RS configuration; receiving, from a network node, one or more messages indicating one or more first subsets of RS ports from the first number of subsets of RS ports; measuring the one or more first subsets of RS ports; and transmitting, to the network node, a report message indicating a measurement for the one or more first subsets of RS ports.

In some embodiments, the step of determining the first number of subsets of RS ports comprises at least one of: receiving, from the network node, a first message indicating the first number of subsets of RS ports; and determining the first number of subsets or RS ports based on a local configuration that is preconfigured or hard-coded at the UE. In some embodiments, at least one of the first message and the one or more messages is received via at least one of: Radio Resource Control (RRC) signaling dedicated to the UE; System Information (SI) broadcasted by the network node; Medium Access Control (MAC) Control Element (CE); and Downlink Control Information (DCI).

In some embodiments, the one or more messages comprise at least one of: a second message indicating a second number of subsets of RS ports comprising the one or more first subsets, each of the second number of subsets belonging to the set of one or more RS ports associated with the same RS configuration; a second message indicating a single subset of RS ports; a third message indicating a third number of subsets of RS ports comprising the one or more first subsets, each of the third number of subsets belonging to the set of one or more RS ports associated with the same RS configuration; a third message indicating a single subset; and a fourth message requesting the UE to report a measurement for RS ports without specifying which subset of RS ports to be measured. In some embodiments, at least one of following is true: the second message indicates one or more of the first number of subsets as the single subset or the second number of subsets; the third message indicates one or more of the first number of subsets as the single subset or the third number of subsets; and the third message indicates one or more of the second number of subsets as the single subset or the third number of subsets when the second message is also received.

In some embodiments, at least one of following is true: the first message is received via RRC signaling or SI broadcasted by the network node; the second message is received via MAC CE; the second message is received via DCI while the third message is not received; and the third message is received via DCI. In some embodiments, a DCI, via which one of the one or more messages is received, comprises a bitfield indicating which one or ones of the one or more subsets are to be measured. In some embodiments, at least one of following is true: each value of the bitfield indicates a corresponding first subset is to be measured; and each bit in the bitfield indicates whether a corresponding first subset is to be measured or not.

In some embodiments, a MAC CE, via which one of the one or more messages is received, comprises a bitfield indicating a part of the first number of subsets as the second number of subsets, and each bit in the bitfield indicates whether a corresponding one of the first number of subsets is indicated as one of the second number of subsets or not. In some embodiments, when the first message is received via SI broadcasted by the network node, the second message and/or the third message are a group common DCI that is transmitted from the network node to a group of UEs comprising the UE. In some embodiments, the step of transmitting the report message comprises: transmitting, to the network node, the report message over a first frequency resource that is different from a second frequency resource used by another UE in the group of UEs for transmitting its report message.

In some embodiments, the step of determining the one or more first subsets of RS ports comprises at least one of: determining the single subset or the third number of subsets indicated by the third message as the one or more first subsets when the third message is received; determining the single subset or the second number of subsets indicated by the second message as the one or more first subsets when the third message is not received and the second message is received; and determining the first number of subsets indicated by the first message as the one or more first subsets when neither the third message nor the second message is received and the first message is received.

In some embodiments, the step of transmitting the report message comprises at least one of: transmitting, to the network node, the report message at a report timing that is determined based on a reception timing at which one of the messages is received and a relationship between the report timing and the reception timing indicated by at least one of the one or more messages; transmitting, to the network node, the report message at a report timing that is determined based on a reception timing at which one of the messages is received and a preconfigured or hardcoded relationship between the report timing and the reception timing; and transmitting, to the network node, the report message further indicating one or more identifiers identifying the one or more first subsets that are actually measured. In some embodiments, the relationship is indicated by a DCI message.

In some embodiments, a number of bits in a bitfield of a DCI message for indicating a first subset of RS ports depends on at least one of: a number of RS ports configured at the UE; a number of subsets of RS ports, that are configured by the network node for the UE and belong to a set of one or more RS ports associated with a same RS configuration; and higher layer signaling. In some embodiments, a minimum time gap between a slot containing a DCI triggering a measurement of a RS port and a slot containing the RS port is defined at the UE. In some embodiments, when the one or more messages comprises a DCI, the DCI is one of: DCI format 1_1; DCI format 1_2; a group common DCI; and a DCI format that is different from any DCI format defined in 3GPP TS 36.212, V17.0.0, 3GPP TS 38.212 v17.0.0, and/or any of their previous releases.

In some embodiments, the method further comprises: determining one or more second subsets of RS ports at least based on at least one of the first message, the one or more messages and another local configuration, each of the second subsets belonging to a set of one or more RS ports associated with another RS configuration; measuring the one or more second subsets of RS ports; and transmitting, to the network node, another report message indicating a measurement for the one or more second subsets of RS ports. In some embodiments, the report message has at least one of: a format that matches the one or more first subsets; and a format that matches the set of one or more RS ports associated with the same RS configuration, wherein the report message indicates a predetermined value for any RS port that is comprised in the set but not comprised in the one or more first subsets. In some embodiments, the method further comprises: receiving, from the network node, a fifth message indicating a determined subset of RS ports that belongs to the set of one or more RS ports associated with the same RS configuration; and periodically measuring the determined subset of RS ports and periodically transmitting, to the network node, a report message indicating a measurement for the determined subsets of RS ports. In some embodiments, the determined subset of RS ports corresponds to an antenna muting pattern that is applied at the network node.

In some embodiments, the fifth message is received via at least one of: RRC signaling dedicated to the UE; SI broadcasted by the network node; MAC CE; and DCI. In some embodiments, the one or more RS ports are CSI-RS ports. In some embodiments, at least one of the one or more subsets of RS ports corresponds to an antenna muting pattern at the network node. In some embodiments, the same RS configuration is a configuration indicating a None-Zero-Power (NZP) CSI-RS resource.

According to a second aspect of the present disclosure, a UE is provided. The UE comprises: a processor; a memory storing instructions which, when executed by the processor, cause the processor to perform the method of any of the first aspect.

According to a third aspect of the present disclosure, a UE is provided. The UE comprises: a determining module configured to determine a first number of subsets of RS ports, each of the subsets belonging to a set of one or more RS ports associated with a same RS configuration; a receiving module configured to receive, from a network node, one or more messages indicating one or more first subsets of RS ports from the first number of subsets of RS ports; a measuring module configured to measure the one or more first subsets of RS ports; and a transmitting module configured to transmit, to the network node, a report message indicating a measurement for the one or more first subsets of RS ports. In some embodiments, the UE may comprise one or more further modules configured to perform the method of any of the first aspect.

According to a fourth aspect of the present disclosure, a method at a network node for facilitating a UE in reporting a measurement for one or more RS ports is provided. The method comprises: determining one or more first subsets of RS ports to be measured by the UE, each of the first subsets belonging to a set of one or more RS ports associated with a same RS configuration; transmitting, to the UE, one or more messages requesting the UE to report a measurement for the one or more first subsets of RS ports, such that the one or more first subsets of RS ports can be determined by the UE at least based on the one or more messages; and receiving, from the UE, a report message indicating a measurement for the one or more first subsets of RS ports.

In some embodiments, at least one of the one or more messages is transmitted via at least one of: RRC signaling dedicated to the UE; SI broadcasted by the network node; MAC CE; and DCI. In some embodiments, the one or more messages comprise at least one of: a first message indicating a first number of subsets of RS ports comprising the one or more first subsets, each of the first number of subsets belonging to the set of one or more RS ports associated with the same RS configuration; a second message indicating a second number of subsets of RS ports comprising the one or more first subsets, each of the second number of subsets belonging to the set of one or more RS ports associated with the same RS configuration; a second message indicating a single subset of RS ports; a third message indicating a third number of subsets of RS ports comprising the one or more first subsets, each of the third number of subsets belonging to the set of one or more RS ports associated with the same RS configuration; a third message indicating a single subset; and a fourth message requesting the UE to report a measurement for RS ports without specifying which subset of RS ports to be measured. In some embodiments, at least one of following is true: the second message indicates one or more of the first number of subsets as the single subset or the second number of subsets when the first message is also transmitted; the third message indicates one or more of the first number of subsets as the single subset or the third number of subsets when the first message is also transmitted; and the third message indicates one or more of the second number of subsets as the single subset or the third number of subsets when the second message is also transmitted.

In some embodiments, at least one of following is true: the first message is transmitted via RRC signaling or SI broadcasted by the network node; the second message is transmitted via MAC CE; the second message is transmitted via DCI while the third message is not transmitted; and the third message is transmitted via DCI.

In some embodiments, a DCI, via which one of the one or more messages is transmitted, comprises a bitfield indicating which one or ones of the one or more subsets are to be measured. In some embodiments, at least one of following is true: each value of the bitfield indicates a corresponding first subset is to be measured; and each bit in the bitfield indicates whether a corresponding first subset is to be measured or not. In some embodiments, a MAC CE, via which one of the one or more messages is transmitted, comprises a bitfield indicating a part of the first number of subsets as the second number of subsets, and each bit in the bitfield indicates whether a corresponding one of the first number of subsets is indicated as one of the second number of subsets or not. In some embodiments, when the first message is transmitted via SI broadcasted by the network node, the second message and/or the third message are a group common DCI that is transmitted from the network node to a group of UEs comprising the UE. In some embodiments, the step of receiving the report message comprises: receiving, from the UE, the report message over a first frequency resource that is different from a second frequency resource used by the network node for receiving another report message from another UE in the group of UEs.

In some embodiments, the step of receiving the report message comprises at least one of: receiving, from the UE, the report message at a report timing that is determined based on a reception timing at which one of the messages is received by the UE and a relationship between the report timing and the reception timing indicated by at least one of the one or more messages; receiving, from the UE, the report message at a report timing that is determined based on a reception timing at which one of the messages is received by the UE and a preconfigured or hardcoded relationship between the report timing and the reception timing; and receiving, from the UE, the report message further indicating one or more identifiers identifying the one or more first subsets that are actually measured. In some embodiments, the relationship is indicated by a DCI message.

In some embodiments, a number of bits in a bitfield of a DCI message for indicating a first subset of RS ports depends on at least one of: a number of RS ports configured at the UE; a number of subsets of RS ports, that are configured by the network node for the UE and belong to a set of one or more RS ports associated with a same RS configuration; and higher layer signaling. In some embodiments, a minimum time gap between a slot containing a DCI triggering a measurement of a RS port and a slot containing the RS port is defined at the network node. In some embodiments, when the one or more messages comprises a DCI, the DCI is one of: DCI format 1_1; DCI format 1_2; a group common DCI; and a DCI format that is different from any DCI format defined in 3GPP TS 36.212, V17.0.0, 3GPP TS 38.212 v17.0.0, and/or any of their previous releases.

In some embodiments, before the step of transmitting the one or more messages, the method further comprises: determining one or more second subsets of RS ports to be measured by the UE, each of the second subsets belonging to a set of one or more RS ports associated with another RS configuration; and wherein after the step of transmitting the one or more messages, the method further comprises: receiving, from the UE, another report message indicating a measurement for the one or more second subsets of RS ports. In some embodiments, the report message has at least one of: a format that matches the one or more first subsets; and a format that matches the set of one or more RS ports associated with the same RS configuration, wherein the report message indicates a predetermined value for any RS port that is comprised in the set but not comprised in the one or more first subsets.

In some embodiments, one or more RS ports that are not comprised in the one or more first subsets are not muted when the UE is measuring the one or more first subsets. In some embodiments, the method further comprises: determining which one or ones of the set of RS ports are to be muted at least based on the report message; and muting the determined one or more RS ports. In some embodiments, the method further comprises at least one of: decoding the report message according to a report format used in decoding the previous report message in response to determining that the report message cannot be decoded correctly; and retransmitting, to the UE, at least one of the one or more messages to request the UE perform the measurement or report the measurement again. In some embodiments, the method further comprises: determining a subset of RS ports to be periodically measured and periodically reported by the UE at least based on the measurement for the one or more first subsets of RS ports, the determined subset of RS ports belonging to the set of one or more RS ports associated with the same RS configuration; transmitting, to the UE, a fifth message indicating the determined subset of RS ports; and periodically receiving, from the UE, a report message indicating a measurement for the determined subsets of RS ports. In some embodiments, the determined subset of RS ports corresponds to an antenna muting pattern that is applied at the network node. In some embodiments, the fifth message is transmitted via at least one of: RRC signaling dedicated to the UE; SI broadcasted by the network node; MAC CE; and DCI.

In some embodiments, the one or more RS ports are CSI-RS ports. In some embodiments, at least one of the one or more subsets of RS ports corresponds to an antenna muting pattern at the network node. In some embodiments, the same RS configuration is a configuration indicating an NZP CSI-RS resource.

According to a fifth aspect of the present disclosure, a network node is provided. The network node comprises: a processor; a memory storing instructions which, when executed by the processor, cause the processor to perform the method of any of the fourth aspect.

According to a sixth aspect of the present disclosure, a network node is provided. The network node comprises: a determining module configured to determine one or more first subsets of RS ports to be measured by the UE, each of the first subsets belonging to a set of one or more RS ports associated with a same RS configuration; a transmitting module configured to transmit, to the UE, one or more messages requesting the UE to report a measurement for the one or more first subsets of RS ports, such that the one or more first subsets of RS ports can be determined by the UE at least based on the one or more messages; and a receiving module configured to receive, from the UE, a report message indicating a measurement for the one or more first subsets of RS ports. In some embodiments, the network node may comprise one or more further modules configured to perform the method of any of the fourth aspect.

According to a seventh aspect of the present disclosure, a computer program comprising instructions is provided. The instructions, when executed by at least one processor, cause the at least one processor to carry out the method of any of the first and fourth aspects.

According to an eighth aspect of the present disclosure, a carrier containing the computer program of the seventh aspect is provided. In some embodiments, the carrier is one of an electronic signal, optical signal, radio signal, or computer readable storage medium.

According to a ninth aspect of the present disclosure, a telecommunications system is provided. The telecommunications network comprises: one or more UEs of the second or third aspect; and at least one network node of the fifth or sixth aspect.

With some embodiments of the present disclosure, the method can help gNB to make the right antenna muting decision before actual perform antenna muting. It may muting patterns or CSI-RS ports combinations/configurations. Further, the method may be used to prepare for antenna muting, i.e., to determine the specific set of ports to mute while maintaining maximal possible performance in the muted state. Actual antenna muting need not be performed when trying out the different hypotheses (or subsets of RS ports) and corresponding muting options, which may reduce the time required for antenna muting and thus improves performance.

### BRIEF DESCRIPTION OF THE DRAWINGS

FIG. 1 is a diagram illustrating an exemplary telecommunications network in which UEs and gNB may be operated according to an embodiment of the present disclosure.

FIG. 2 is a diagram illustrating an exemplary overview of CSI-RS parameters and its configurations with which measuring and/or reporting for subsets of RS ports may be applicable according to an embodiment of the present disclosure.

FIG. 3A and FIG. 3B are diagrams illustrating exemplary antenna panels with which measuring and/or reporting for subsets of RS ports may be applicable according to an embodiment of the present disclosure.

FIG. 4 is a diagram illustrating exemplary MAC CEs that can be used for measuring and/or reporting for subsets of RS ports according to an embodiment of the present disclosure.

FIG. 5A and FIG. 5B are diagrams illustrating exemplary antenna panels with different subsets of RS ports selected by the UE for measuring and/or reporting according to an embodiment of the present disclosure.

FIG. 6 is a diagram illustrating an exemplary dynamic change between different subsets of RS ports according to an embodiment of the present disclosure.

FIG. 7 is a diagram illustrating an exemplary scenario in which subsets of CSI-RS ports to be measured and/or reported are indicated by the gNB before and after antenna muting is performed according to an embodiment of the present disclosure.

FIG. 8 is a flow chart illustrating an exemplary method at a UE for reporting a measurement for RS ports according to an embodiment of the present disclosure.

FIG. 9 is a flow chart illustrating an exemplary method at a network node for facilitating a UE in reporting a measurement for RS ports according to an embodiment of the present disclosure.

FIG. 10 schematically shows an embodiment of an arrangement which may be used in a UE or a network node according to an embodiment of the present disclosure.

FIG. 11 is a block diagram of an exemplary UE according to an embodiment of the present disclosure.

FIG. 12 is a block diagram of an exemplary network node according to an embodiment of the present disclosure.

FIG. 13 schematically illustrates a telecommunication network connected via an intermediate network to a host computer according to an embodiment of the present disclosure.

FIG. 14 is a generalized block diagram of a host computer communicating via a base station with a user equipment over a partially wireless connection according to an embodiment of the present disclosure.

FIG. 15 to FIG. 18 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as a RS measurement reporting is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, although some embodiments are described in the context of “CSI-RS”, the present disclosure is not limited thereto. In some other embodiments, another type of reference signal may be involved, for example Sounding Reference Signal (SRS), Demodulation Reference Signal (DMRS), Phase Tracking Reference Signal (PT-RS) or any other reference signals that are applicable to the teaching of the present disclosure.

Further, following 3GPP documents are incorporated herein by reference in their entireties:
3GPP TS 38.211 V17.0.0 (2021-12), Technical Specification, 3rd Generation Partnership Project; Technical Specification Group Radio Access Network; NR; Physical channels and modulation (Release 17);
3GPP TS 38.214 V17.0.0 (2021-12), Technical Specification, 3rd Generation Partnership Project; Technical Specification Group Radio Access Network; NR; Physical layer procedures for data (Release 17);
3GPP TS 38.321 V16.7.0 (2021-12), Technical Specification, 3rd Generation Partnership Project; Technical Specification Group Radio Access Network; NR; Medium Access Control (MAC) protocol specification (Release 16); and
3GPP TS 38.331 V16.7.0 (2021-12), Technical Specification, 3rd Generation Partnership Project; Technical Specification Group Radio Access Network; NR; Radio Resource Control (RRC) protocol specification (Release 16).

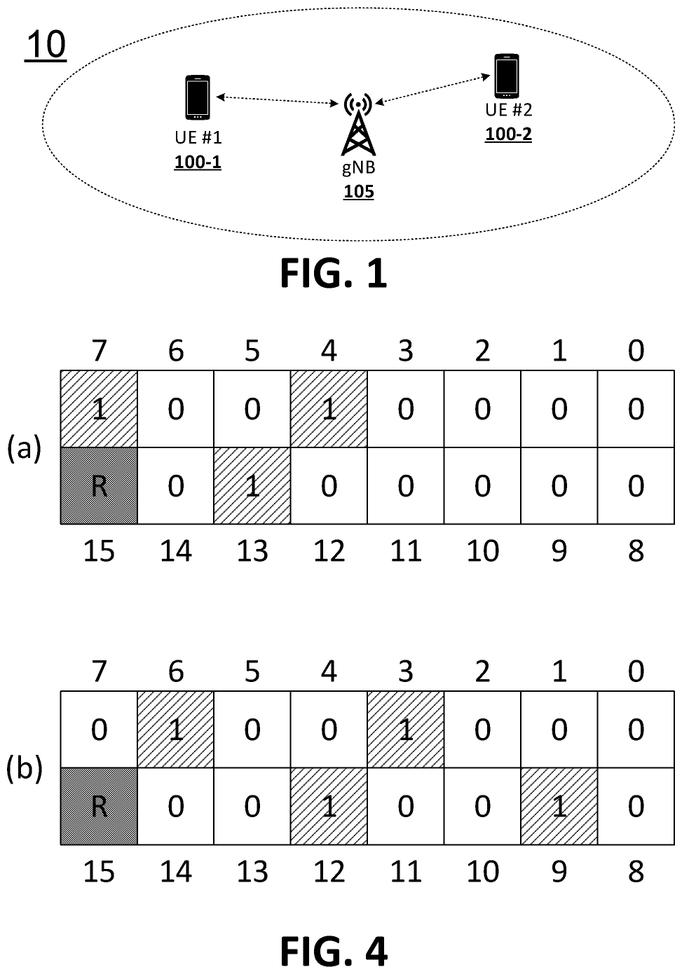

FIG. 1 is a diagram illustrating an exemplary telecommunications network 10 in which UE #1 100-1, UE #2 100-2, and gNB 105 may be operated according to an embodiment of the present disclosure. Although the telecommunications network 10 is a network defined in the context of 5G NR, the present disclosure is not limited thereto.

As shown in FIG. 1, the network 10 may comprise one or more UEs 100-1 and 100-2 (collectively, UE(s) 100) and a RAN node 105, which could be a base station, a Node B, an evolved NodeB (eNB), a gNB, or an AN node which provides the UEs 100 with access to the network. Further, the network 10 may comprise its core network portion that is not shown in FIG. 1.

However, the present disclosure is not limited thereto. In some other embodiments, the network 10 may comprise additional nodes, less nodes, or some variants of the existing nodes shown in FIG. 1. For example, in a network with the 4G architecture, the entities (e.g., an eNB) which perform these functions may be different from those (e.g., the gNB 105) shown in FIG. 1. For another example, in a network with a mixed 4G/5G architecture, some of the entities may be same as those shown in FIG. 1, and others may be different.

Further, although two UEs 100 and one gNB 105 are shown in FIG. 1, the present disclosure is not limited thereto. In some other embodiments, any number of UEs and/or any number of gNBs may be comprised in the network 10.

As shown in FIG. 1, the UEs 100 may be communicatively connected to the gNB 105 which in turn may be communicatively connected to a corresponding Core Network (CN) and then the Internet, such that the UEs 100 may finally communicate its user plane data with other devices outside the network 10, for example, via the gNB 105.

As mentioned above, CSI-RS reporting is one of crucial features that enable a power efficient RAN. In NR, the CSI-RS generation procedures are defined in 3GPP TS 38.211 Section 7.4.1.5. The CSI-RS may be used for time/frequency tracking, CSI computation, L1-Reference Signal Received Power (L1-RSRP) computation, L1-Signal to Interference plus Noise Ratio (L1-SINR) computation and mobility. Configured with CSI-RS, the UE then needs to follow the procedures described in 3GPP TS 38.214 Section 5.1.6.1.

For a CSI-RS resource associated with an NZP-CSI-RS-ResourceSet with the higher layer parameter repetition set to ‘on’, the UE shall not expect to be configured with CSI-RS over the symbols during which the UE is also configured to monitor the Control Resource Set (CORESET), while for other NZP-CSI-RS-ResourceSet configurations, if the UE is configured with a CSI-RS resource and a search space set associated with a CORESET in the same OFDM symbol(s), the UE may assume that the CSI-RS and a PDCCH DM-RS transmitted in all the search space sets associated with CORESET are quasi co-located with ‘typeD’, if ‘typeD’ is applicable. This also applies to the case when CSI-RS and the CORESET are in different intra-band component carriers, if ‘typeD’ is applicable. Furthermore, the UE shall not expect to be configured with the CSI-RS in Physical Resource Blocks (PRBs) that overlap those of the CORESET in the Orthogonal Frequency Division Multiplexing (OFDM) symbols occupied by the search space set(s).

The UE is not expected to receive CSI-RS and SIB1 message in the overlapping PRBs in the OFDM symbols where SIB1 is transmitted.

If the UE is configured with Discontinuous Reception (DRX),
if the UE is configured to monitor DCI format 2_6 and configured by higher layer parameter ps-TransmitOtherPeriodicCSI to report CSI with the higher layer parameter reportConfigType set to ‘periodic’ and reportQuantity set to quantities other than ‘cri-RSRP’ and ‘ssb-Index-RSRP’ when drx-onDurationTimer in DRX-Config is not started, the most recent CSI measurement occasion occurs in DRX active time or during the time duration indicated by drx-onDurationTimer in DRX-Config also outside DRX active time for CSI to be reported;
if the UE is configured to monitor DCI format 2_6 and configured by higher layer parameter ps-TransmitPeriodicL1-RSRP to report L1-RSRP with the higher layer parameter reportConfigType set to ‘periodic’ and reportQuantity set to cri-RSRP when drx-onDuration Timer in DRX-Config is not started, the most recent CSI measurement occasion occurs in DRX active time or during the time duration indicated by drx-onDurationTimer in DRX-Config also outside DRX active time for CSI to be reported;
otherwise, the most recent CSI measurement occasion occurs in DRX active time for CSI to be reported.

According to the specification of NR, i.e., 3GPP TS 38.214 section 5.2.2.3.1, a UE can be configured with one or more NZP CSI-RS resource set configuration(s) as indicated by the higher layer parameters CSI-ResourceConfig, and NZP-CSI-RS-ResourceSet. Each NZP CSI-RS resource set consists of K>1 NZP CSI-RS resource(s). The following is captured from TS 38.331 regarding CSI-ResourceConfig.

CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

```
      nzp-CSI-RS-ResourceSetList SEQUENCE (SIZE
(1..maxNrofNZP-CSI-RS-ResourceSetsPerConfig)) OF
NZP-CSI-RS-ResourceSetId
OPTIONAL, -- Need R
      csi-SSB-ResourceSetList SEQUENCE (SIZE
      (1..maxNrofCSI-SSB-ResourceSetsPerConfig))
OF CSI-SSB-ResourceSetId OPTIONAL -- Need R
    },
    csi-IM-ResourceSetList SEQUENCE (SIZE
(1..maxNrofCSI-IM-ResourceSetsPerConfig)) OF CSI-IM-ResourceSetId
  },
```

| | |
|---|---|
| bwp-Id | BWP-Id, |
| resourceType | ENUMERATED { aperiodic, |
| | semiPersistent, periodic }, |

...
}
-- TAG-CSI-RESOURCECONFIG-STOP
-- ASN1STOP

While below is the NZP-CSI-RS-ResourceSet.

NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |

(1..maxNrofNZP-CSI-RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER (0..6) |

OPTIONAL, -- Need S

| | |
|---|---|
| trs-Info | ENUMERATED {true} |

```
OPTIONAL, -- Need R
  ...,
  [[
```

| | |
|---|---|
| aperiodicTriggeringOffset-r16 | INTEGER (0..31) |

OPTIONAL -- Need S
]]
}
-- TAG-NZP-CSI-RS-RESOURCESET-STOP
-- ASN1STOP

In each NZP CSI-RS resources, the NW can set the CSI-RS resource with different powerControlOffset, scramblingID, etc. The following is captured from TS 38.331.

NZP-CSI-RS-Resource information element

-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | OPTIONAL, -- Need R |
| scramblingID | ScramblingId, | |
| periodicityAndOffset | CSI-ResourcePeriodicityAndOffset | OPTIONAL, -- Cond |

PeriodicOrSemiPersistent

| | | |
|---|---|---|
| qcl-InfoPeriodicCSI-RS | TCI-StateId | OPTIONAL, -- Cond |

Periodic
...
}
-- TAG-NZP-CSI-RS-RESOURCE-STOP
-- ASN1STOP

Before transmitted, the CSI-RS is mapped according to the configured CSI-RS-ResourceMapping. There, the NW could set the configuration of the cdm-Type, frequencyDomainAllocation, nrofPorts, etc.

CSI-RS-ResourceMapping information element

-- ASN1START
-- TAG-CSI-RS-RESOURCEMAPPING-START

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED {p1,p2,p4,p8,p12,p16,p24,p32}, |
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, cdm4-FD2-TD2, cdm8-FD2-TD4}, |
| density | CHOICE { |
| dot5 | ENUMERATED {evenPRBs, oddPRBs}, |
| one | NULL, |
| three | NULL, |
| spare | NULL |

},

| | |
|---|---|
| freqBand | CSI-FrequencyOccupation, |

...
}
-- TAG-CSI-RS-RESOURCEMAPPING-STOP
-- ASN1STOP

The explanation of the CSI-RS parameters can be found in TS. 38.214 section 5.2.2.3.1:
nzp-CSI-RS-ResourceId determines CSI-RS resource configuration identity.
periodicityAndOffset defines the CSI-RS periodicity and slot offset for periodic/semi-persistent CSI-RS. All the CSI-RS resources within one set are configured with the same periodicity, while the slot offset can be same or different for different CSI-RS resources.
resourceMapping defines the number of ports, CDM-type, and OFDM symbol and subcarrier occupancy of the CSI-RS resource within a slot that are given in Clause 7.4.1.5 of TS 38.211.
nrofPorts in resourceMapping defines the number of CSI-RS ports, where the allowable values are given in Clause 7.4.1.5 of TS 38.211.
density in resourceMapping defines CSI-RS frequency density of each CSI-RS port per PRB, and CSI-RS PRB offset in case of the density value of ½, where the allowable values are given in Clause 7.4.1.5 of TS 38.211. For density ½, the odd/even PRB allocation indicated in density is with respect to the common resource block grid.
cdm-Type in resourceMapping defines CDM values and pattern, where the allowable values are given in Clause 7.4.1.5 of TS 38.211.
powerControlOffset: which is the assumed ratio of Physical Downlink Shared Channel (PDSCH) Energy Per Resource Element (EPRE) to NZP CSI-RS EPRE when UE derives CSI feedback and takes values in the range of [−8, 15] dB with 1 dB step size.
powerControlOffsetSS: which is the assumed ratio of NZP CSI-RS EPRE to Synchronous Signal (SS)/Physical Broadcast Channel (PBCH) block EPRE.
scramblingID defines scrambling ID of CSI-RS with length of 10 bits.
BWP-Id in CSI-ResourceConfig defines which bandwidth part the configured CSI-RS is located in.
qcl-InfoPeriodicCSI-RS contains a reference to a Transmission Configuration Indicator (TCI)-State indicating Quasi co-location (QCL) source RS(s) and QCL type(s). If the TCI-State is configured with a reference to an RS configured with qcl-Type set to ‘typeD’ association, that RS may be an SS/PBCH block located in the same or different component carrier (CC)/DL Bandwidth Part (BWP) or a CSI-RS resource configured as periodic located in the same or different CC/DL BWP.

The CSI-RS resource (or the CSI-RS resource-set) that the UE needs to measure is configured in RRC configuration, e.g., in the CSI-MeasConfig information element (IE). In that mentioned IE, the NW, based on its certain consideration, may add, or remove (release) the CSI-RS or the (CSI-RS resource-set) that UE needs to measure. The following is captured from 3GPP TS 38.331.

-- ASN1START
-- TAG-CSI-MEASCONFIG-START

| | |
|---|---|
| CSI-MeasConfig ::= | SEQUENCE { |
| nzp-CSI-RS-ResourceToAddModList | SEQUENCE (SIZE (1..maxNrofNZP-CSI-RS-Resources)) OF |

NZP-CSI-RS-Resource OPTIONAL, -- Need N

| | |
|---|---|
| nzp-CSI-RS-ResourceToReleaseList | SEQUENCE (SIZE (1..maxNrofNZP-CSI-RS-Resources)) OF |

```
NZP-CSI-RS-ResourceId OPTIONAL, -- Need N
  nzp-CSI-RS-ResourceSetToAddModList SEQUENCE (SIZE (1..maxNrofNZP-CSI-RS-ResourceSets))
OF NZP-CSI-RS-ResourceSet OPTIONAL, -- Need N
  nzp-CSI-RS-ResourceSetToReleaseList SEQUENCE (SIZE (1..maxNrofNZP-CSI-RS-ResourceSets))
OF NZP-CSI-RS-ResourceSetId
```

| | |
|---|---|
| csi-IM-ResourceToAddModList | SEQUENCE (SIZE (1..maxNrofCSI-IM-Resources)) OF |

CSI-IM-Resource OPTIONAL, -- Need N

| | |
|---|---|
| csi-IM-ResourceToReleaseList | SEQUENCE (SIZE (1..maxNrofCSI-IM-Resources)) OF |

CSI-IM-ResourceId OPTIONAL, -- Need N

| | |
|---|---|
| csi-IM-ResourceSetToAddModList | SEQUENCE (SIZE (1..maxNrofCSI-IM-ResourceSets)) OF |

CSI-IM-ResourceSet OPTIONAL, -- Need N

| | |
|---|---|
| csi-IM-ResourceSetToReleaseList | SEQUENCE (SIZE (1..maxNrofCSI-IM-ResourceSets)) OF |

CSI-IM-ResourceSetId OPTIONAL, -- Need N

| | |
|---|---|
| csi-SSB-ResourceSetToAddModList | SEQUENCE (SIZE (1..maxNrofCSI-SSB-ResourceSets)) OF |

CSI-SSB-ResourceSet OPTIONAL, -- Need N

| | |
|---|---|
| csi-SSB-ResourceSetToReleaseList | SEQUENCE (SIZE (1..maxNrofCSI-SSB-ResourceSets)) OF |

CSI-SSB-ResourceSetId OPTIONAL, -- Need N

| | |
|---|---|
| csi-ResourceConfigToAddModList | SEQUENCE (SIZE (1..maxNrofCSI-ResourceConfigurations)) |

OF CSI-ResourceConfig
OPTIONAL, -- Need N

| | |
|---|---|
| csi-ResourceConfigToReleaseList | SEQUENCE (SIZE (1..maxNrofCSI-ResourceConfigurations)) |

OF CSI-ResourceConfigId
OPTIONAL, -- Need N

| | |
|---|---|
| csi-ReportConfigToAddModList | SEQUENCE (SIZE (1..maxNrofCSI-ReportConfigurations)) |

OF CSI-ReportConfig OPTIONAL, -- Need N

| | |
|---|---|
| csi-ReportConfigToReleaseList | SEQUENCE (SIZE (1..maxNrofCSI-ReportConfigurations)) |

OF CSI-ReportConfigId
OPTIONAL, -- Need N

| | |
|---|---|
| reportTriggerSize | INTEGER (0..6) |

OPTIONAL, -- Need M

| | |
|---|---|
| aperiodicTriggerStateList | SetupRelease { CSI-AperiodicTriggerStateList } |

```
OPTIONAL, -- Need M
  semiPersistentOnPUSCH-TriggerStateList SetupRelease {
  CSI-SemiPersistentOnPUSCH-TriggerStateList }
OPTIONAL, -- Need M
  ...,
  [[
```

| | |
|---|---|
| reportTriggerSizeDCI-0-2-r16 | INTEGER (0..6) |

OPTIONAL -- Need R
]]
}
-- TAG-CSI-MEASCONFIG-STOP
-- ASN1STOP

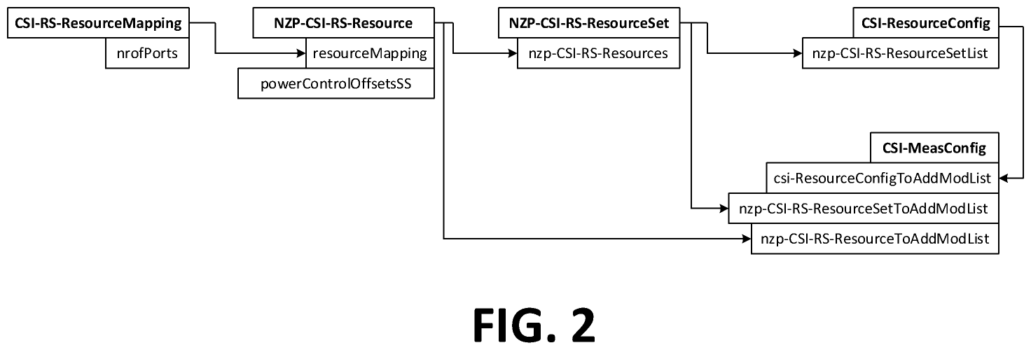

FIG. 2 shows the overview of CSI-RS parameters that was discussed above. Each parameter may be composed of several configurations, e.g., CSI-RS-ResourceMapping may be composed of nrofPorts, or NZP-CSI-RS-Resource may be composed of resourceMapping and powerControlOffsetsSS parameters. For simplicity, FIG. 2 does not include all the configurations for each parameter. It can be observed in FIG. 2 that parameters are simply a mapping with each other using its different configurations. Most of them are mapped to CSI-MeasConfig.

After receiving the CSI-RS, the UE may then report its measurement back to the NW. The reporting configuration for CSI can be aperiodic (using Physical Uplink Shared Channel, or PUSCH), periodic (using Physical Uplink Control Channel, or PUCCH) or semi-persistent (using PUCCH, and DCI activated PUSCH). The CSI-RS Resources can be periodic, semi-persistent, or aperiodic. Table 5.2.1.4-1 in TS 38.214 (rewritten below) shows the supported combinations of CSI Reporting configurations and CSI-RS Resource configurations and how the CSI Reporting is triggered for each CSI-RS Resource configuration.

TABLE 1
Triggering/Activation of CSI Reporting for the possible CSI-RS Configurations

| CSI-RS | Periodic CSI | Semi-Persistent | Aperiodic CSI |
|---|---|---|---|
| Configuration | Reporting | CSI Reporting | Reporting |
| Periodic CSI-RS | No dynamic | For reporting on | Triggered by DCI; |
| | triggering/ | PUCCH, the UE | additionally, |
| | activation | receives an | subselection |
| | | activation | indication as |
| | | command, as | described in clause |
| | | described in clause | 6.1.3.13 of TS |
| | | 6.1.3.16 of TS | 38.321 possible as |
| | | 38.321; for | defined in Clause |
| | | reporting on PUSCH, | 5.2.1.5.1. |
| | | the UE receives | |
| | | triggering on DCI | |
| Semi-Persistent | Not Supported | For reporting on | Triggered by DCI; |
| CSI-RS | | PUCCH, the UE | additionally, |
| | | receives an | subselection |
| | | activation | indication as |
| | | command, as | described in clause |
| | | described in clause | 6.1.3.13 of TS |
| | | 6.1.3.16 of TS | 38.321 possible as |
| | | 38.321; for | defined in Clause |
| | | reporting on PUSCH, | 5.2.1.5.1. |
| | | the UE receives | |
| | | triggering on DCI | |
| Aperiodic CSI-RS | Not Supported | Not Supported | Triggered by DCI; |
| | | | additionally, |
| | | | subselection |
| | | | indication as |
| | | | described in clause |
| | | | 6.1.3.13 of TS |
| | | | 38.321 possible as |
| | | | defined in Clause |
| | | | 5.2.1.5.1. |

In some embodiments, methods and mechanisms are disclosed that allow for a faster and resource-efficient dynamic CSI-RS configuration adaptation, by using the following alternatives:
Configuring multiple resource mappings, or multiple configurations per parameter within a CSI-RS resource, e.g., different number of ports, power control offset, QCL info, etc., and using MAC CE or DCI to activate/deactivate a certain configuration (or switch between those configurations).
Configuring multiple CSI-RS resources within one CSI-RS resource set and using MAC CE or DCI to activate/deactivate the configured CSI-RS resources (or switching between CSI-RS resources).
Configuring multiple CSI-RS resource sets and using MAC CE or DCI to activate/deactivate one or more configured CSI-RS resource set (or switching between CSI-RS resource sets).
Other CSI-RS parameters included in CSI-MeasConfig can have multiple CSI-RS configurations and using MAC CE or DCI to activate/deactivate one or more configured CSI-RS resource set (or switching between CSI-RS resource sets).

In some embodiments, it may be assumed that the UE is configured with more than one CSI-RS configuration. These embodiments aim to provide a fast dynamic adaptation mechanism, in which the UE can be indicated to switch between different CSI-RS configurations. The switching, can be for example, done by the NW during the port adaptation, i.e., where the NW determines to change the number of ports that will be used to serve the respective UE.

In some embodiments, the term “multiple CSI-RS configurations” may refer to multiple CSI-RS configurations that can be activated/deactivated or switched through MAC-CE or DCI signaling.

In one example, a bitfield in a DCI can indicate if the default configuration or another one is activated. For example, the UE may be configured with a first CSI-RS configuration and a second CSI-RS configuration with the first one as the default. An additional bit in the DCI, e.g., DCI 1_1 and/or DCI 1_2 can be configured where if the bit status is “1”, the UE receives the bit and thereby considers the second CSI-RS configuration as activated and the default one as deactivated. A bit “0” can be considered as reserved, or that the UE should consider the default CSI-RS configuration as the active one. In another example, the number of bits in the DCI may depend on the number of CSI-RS configurations. For example, 2 bits may correspond to four CSI-RS configurations where 00 may refer to the default CSI-RS configuration.

In some embodiments below, when multiple configurations are not set for the UE, a legacy behavior may apply. For example, the UE needs to monitor all of the CSI-RS, which is included in, e.g., CSI-MeasConfig. In some embodiments, the additional bitfield in the DCI used for adaptation indication may not be included in the DCI transmitted to the UE.

By configuring the UE with multiple CSI-RS configurations that can be activated/deactivated or switched (through MAC-CE or DCI), the NW may have flexibility on which CSI-RS should be used at one time instance. The active CSI-RS configurations can be selected by the NW based on, e.g., the state of the port adaptation. For example, the following mechanism can be used by the NW to exploit the multiple CSI-RS configurations.

1. Configuring the UE with Multiple CSI-RS Configurations.

Here, the multiple CSI-RS configurations can be obtained by one of several approaches mentioned above, for example, by configuring the UE to have more than one parameter configuration, for example, parameters inside the CSI-RS-ResourceMapping IE.

2. Indicating the UE to Switch from the First CSI-RS Configuration to the Second CSI-RS Configuration.

The NW may decide to change the CSI-RS configuration, for example, when there is no more UEs active in the cell, or no UEs are active that require or can take advantage of transmission with a large number of ports, e.g., sustained transmission with multiple layers and narrow beams. In this situation, the NW may decide to switch from the first CSI-RS configuration suitable for a larger number of ports transmission to the second CSI-RS configuration suitable for a smaller number of ports transmission. As described above, the indication can be done, e.g., via DCI and/or MAC-CE.

3. After Sending the Switching Indication, the NW May then Transmit the CSI-RS According to the Second CSI-RS Configuration.

In all the examples above, the NW can configure the UE through higher layer signaling e.g., RRC signaling if the activation/deactivation mechanism is DCI based, MAC CE based and also the underlying configuration, e.g., bitfield and its interpretation in the DCI. Alternatively, the UE can be pre-configured e.g., as in standardization documentations, e.g., if there are two fields configured for a parameter, e.g., number of ports, then the UE automatically expects a MAC CE or DCI to be able to activate or deactivate the configurations, as determined in the standards for example.

On the UE side, the UE may receive a first CSI-RS configuration and a second CSI-RS configuration according to the example embodiments described herein, for example, through RRC signaling. The UE then may start measuring or report based on the first configuration as the default one, and at one time instant, the UE may receive a MAC CE command or a DCI indicating that the UE should perform measurements or reporting based on the second configuration, and thus the UE measures the CSI-RS based on the second configuration or report CSI based on measuring the second CSI-RS configuration.

In some embodiments, a group of UEs may receive command to switch to a second configuration. This may for example be implemented as a group MAC or a DCI using group common search space. Then a group of UEs can be configured to, using low signaling overhead and low latency, switch CSI-RS configurations. The individual CSI-RS configurations may still be configured per-UE. The group switching command can for example be formulated as:
all UEs in group switch to specific configuration index, for example, switch to nzp-CSI-RS-ResourcesDefault or nzp-CSI-RS-ResourcesB.
all UEs in group switch to an implicitly indicated configuration, for example, switch to CSI-RS configuration with shortest periodicity, densest allocation in time/frequency, largest number of ports, etc.

However, there are still some problems with the embodiments described above. For example, it requires to configure UE with multiple CSI-RS resources so that UE can measure a different number or sets of CSI-RS ports. This will consume many resources when multiple CSI-RS ports combination needs to be measured. Furthermore, when using MAC CE or DCI to indicate to UE which CSI-RS resource to measure, it is associated with actual antenna muting. Since it takes time for hardware to turn on and off, the overhead of this solution is also high.

Some embodiments of the present disclosure propose a method where multiple hypotheses are defined and linked to the one CSI-RS resource. Please note that the term “hypothesis” or “assumption” used in some embodiment may refer to a subset of CSI-RS ports (or generally speaking, a subset of RS ports) that is associated with a CSI-RS configuration (or an RS configuration or RS resource associated therewith). In some embodiments, the term “hypothesis” may be used to indicate one of the multiple options or possibilities for CSI-RS port activation that the NW may apply, out of a set of a larger number of such options. The current hypothesis may be provided to the UE via MAC CE or DCI signaling. In some embodiments, the current hypothesis is not detected by the UE e.g., via blind detection.

In some embodiments, the subset of RS ports may be a proper subset that belongs to a universal or complete set of RS ports associated with an RS configuration. In some other embodiments, the subset of RS ports may be the universal or complete set of RS ports associated with an RS configuration.

As mentioned above, a hypothesis may determine a selection of subset of configured CSI-RS ports—how many and which—to measure. Further, in some embodiments, a hypothesis may determine at which rate the selection of the subset of configured CSI-RS ports is measured. These hypotheses can be either predefined in spec or configured by RRC, or in other higher layer signaling approaches such as SI broadcast.

In some embodiments, MAC CE may be used to select a subset of hypotheses from the complete set, for example, when the number of hypotheses of interest is high. In some embodiments, DCI may be used to indicate one specific hypothesis that UE needs to apply when performing and reporting its measurement.

With these embodiments, no actual antenna muting needs to be executed when UE measures RS ports (e.g., CSI-RS ports) with different hypotheses.

In some embodiments, the UE may be configured with multiple hypotheses which are associated with one NZP CSI-RS resource, where each hypothesis may determine how many, which CSI-RS ports, within the configured CSI-RS resource need to be measured. In some embodiments, hypotheses may be either predefined or configured using RRC, or other types of higher layer signaling such as SI broadcast. In some embodiments, a subset of hypothesis can be selected via MAC CE when there are too many hypotheses that cannot be indicated directly in DCI. In some embodiments, a bitfield may be defined in DCI to indicate which hypothesis that UE shall apply to do measurement. In some embodiments, the timing from receiving this DCI with hypothesis at UE to the reception of the measurement report at gNB may be clearly defined, either based on pre-configuration or indicated in the DCI. In some embodiments, the UE measurement report may be extended to carry the hypothesis number so that at the gNB it is clearly understood which hypothesis the report is associated with. This could be an alternative to the timing method in the previous embodiment. In some embodiments, no CSI-RS port muting is performed during change of hypothesis.

With some embodiments of the present disclosure, the method can help gNB to make the right antenna muting decision before actual perform antenna muting. It may muting patterns or CSI-RS ports combinations/configurations. Further, the method may be used to prepare for antenna muting, i.e., to determine the specific set of ports to mute while maintaining maximal possible performance in the muted state. Actual antenna muting need not be performed when trying out the different hypotheses and corresponding muting options, which may reduce the time required for antenna muting and thus improves performance.

Currently, UE configured with N CSI-RS ports will measure all N ports so that it can get a whole picture of the channel from gNB to UE. gNB uses the measurement report from UE to determine how to transmit data to UE via these antenna ports. For energy saving scenarios, sometimes it is not necessary for the gNB to turn on all N ports all the time, or to keep the same transmission rate and/or bandwidth (BW) on all ports. However, it is not clear which CSI-RS ports and how many CSI-RS ports should be activated.

It is a bit resource-heavy to configure UE with multiple CSI-RS resources where each one corresponds to one possible antenna muting pattern. Furthermore, it takes time to mute the antenna and then ask UE to measure according to the muted pattern especially when it is not clear which antenna ports and how many antennas ports need to be muted as there could be quite many options, with different performance implications, for gNB to try.

Some embodiments of the present disclosure enable gNB to get measurement reports for some of the configured CSI-RS ports using one CSI-RS resource without going into the actual muting action. For example, for an N ports CSI-RS resource, gNB may configure UE with multiple hypotheses, each hypothesis may be associated with which ports within this N ports CSI-RS need be measured.

In some embodiments, RRC signaling can be used to define a set with a quite many hypotheses if needed. In some embodiments, MAC CE can be (optionally) used to activate a subset within the complete set. In some embodiments, DCI can be used to indicate to UE which hypothesis UE needs to measure.

In some embodiments, instead of RRC signaling, other types of higher layer signaling such as SI broadcast can also be used. This is particularly useful if the CSI-RS and its underlying hypothesis are broadcasted to all the UEs within a cell and thus, it is useful to include that in a System Information Block (SIB). In this case, in one embodiment, the NW may decide to use a group common DCI, e.g., a DCI which is scrambled with a group or cell level RNTI to trigger the report from all or some of the UEs within a cell related to a hypothesis. This can lead to saving resources on the NW side and being able to react faster in applying a specific muting pattern.

In some embodiments, gNB does not mute antenna or CSI-RS ports during the occasions when gNB asks UE to measure. It is just like the normal aperiodic CSI trigger and measurement. The difference is that now UE only measures a portion of CSI-RS ports in a CSI-RS resource as enabled by the MAC CE or indicated in DCI. In some embodiments, with the clear timing from the aperiodic CSI trigger to the measurement report, the gNB may know clearly which CSI-RS ports are associated with the measurement report sent from UE. Additionally or alternately, the UE can in the report indicate a hypothesis index/identity so that the gNB can associate the measurement to the correct hypothesis.

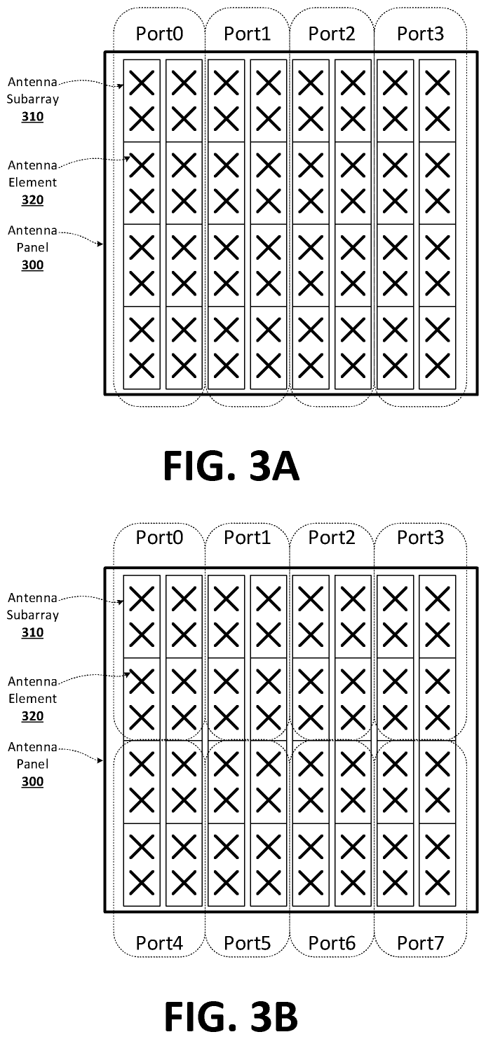

FIG. 3A and FIG. 3B are diagrams illustrating exemplary antenna panels with which measuring and/or reporting for subsets of RS ports may be applicable according to an embodiment of the present disclosure. An antenna panel 300 is shown in FIG. 3A on which multiple antenna subarrays 310 of antenna element 320 are provided. As also shown in FIG. 3A, 4 CSI-RS ports may be mapped to the antenna elements 320, respectively. For example, the CSI-RS port 0 is mapped to the leftmost two columns of antenna elements 320, while the CSI-RS port 3 is mapped to the rightmost two columns of antenna elements 320. Further, the CSI-RS port 1 is mapped to the two middle-left columns while the CSI-RS port 2 is mapped to the two middle-right columns.

However, the present disclosure is not limited thereto. For example, the 4 CSI-RS ports may be mapped to the antenna panel 300 in various manners. In some embodiments, the CSI-RS port 0 is mapped to the topmost two columns of antenna elements 320, while the CSI-RS port 3 is mapped to the bottommost two columns of antenna elements 320. Further, the CSI-RS port 1 is mapped to the two upper-middle columns while the CSI-RS port 2 is mapped to the two lower-middle columns. In fact, the mapping from CSI-RS ports to antenna elements can be determined in any appropriate manner.

Further, the number of CSI-RS ports is not limited to 4 CSI-RS ports shown in FIG. 3A. In some other embodiments, for example, as shown in FIG. 3B, 8 CSI-RS ports are shown. Generally speaking, any appropriate number of CSI-RS ports may be applicable to the embodiments of the present disclosure.

Referring back to FIG. 3A which shows a 4 ports CSI-RS configuration, gNB can define a set of 15 hypotheses for the 4 ports CSI-RS configuration and signals it to the UE, for example, through RRC signaling. In some embodiments, these hypotheses below can be predefined in specification (e.g., pre-configured or hard-coded) as well. An exemplary table of hypotheses is provided below:

In some other embodiments, another table may be defined, for example:

TABLE 2
Exemplary definition of hypotheses

| | CSI-RS Ports combination |
|---|---|
| Hypothesis index | within a hypothesis |
| 0 | 0 |
| 1 | 1 |
| 2 | 2 |
| 3 | 3 |
| 4 | 0, 1 |
| 5 | 0, 2 |
| 6 | 0, 3 |
| 7 | 1, 2 |
| 8 | 1, 3 |
| 9 | 2, 3 |
| 10 | 0, 1, 2 |
| 11 | 0, 1, 3 |
| 12 | 0, 2, 3 |
| 13 | 1, 2, 3 |
| 14 | 0, 1, 2, 3 |

However, the present disclosure is not limited thereto. In some other embodiments, another table may be defined, for example:

TABLE 3
Exemplary definition of hypotheses

| | CSI-RS Ports combination |
|---|---|
| Hypothesis index | within a hypothesis |
| 0 | 0 |
| 1 | 1 |
| 2 | 2 |
| 3 | 3 |
| 4 | 0, 1 |
| 5 | 2, 3 |
| 6 | 0, 1, 2 |
| 7 | 1, 2, 3 |

Referring back to Table 2, it is supposed that there are only 2 bits in DCI to indicate hypothesis. In this case, it is not possible to indicate which hypothesis out of 15 options by using only 2 bits. Therefore, a MAC CE can be used to select a subset of hypotheses defined in RRC signaling. Some exemplary fields of MAC CE are shown in FIG. 4. As shown in (a) and (b) of FIG. 4, when a bit of the field set to 1, it means the corresponding hypothesis is selected. For example, hypotheses with indexes of 4, 7, and 13 are selected as shown in (a) of FIG. 4, while hypotheses with indexes of 3, 6, 9, and 12 are selected as shown in (b) of FIG. 4.

With such a MAC CE, 2 bits in DCI may be used to indicate which of the hypotheses indicated by the MAC CE shall be measured and reported by UE. For example, with the MAC CE shown in (a) of FIG. 4 previously received at the UE, a bitfield in DCI with “00” may refer to the hypothesis with index 4, the bitfield with “01” may refer to the hypothesis with index 7, and the bitfield with “10” may refer to the hypothesis with index 13. However, the present disclosure is not limited thereto. In some other embodiments, a different interpretation of the DCI bits can be applied. For example, the bitfield with “10” in DCI may refer to the hypothesis with index 4, the bitfield with “00” may refer to the hypothesis with index 7, and the bitfield with “01” may refer to the hypothesis with index 13. In fact, as long as UE and gNB agree on a same interpretation of the DCI bits, the interpretation may function properly.

Further, although the embodiment above is described such that each value of the bitfield indicates a corresponding hypothesis to be measured, the present disclosure is not limited thereto. In some other embodiments, each bit in the bitfield may indicate whether a corresponding hypothesis is to be measured or not. For example, when the bitfield in DCI has 3 bits, then each bit with a value of “1” may indicate a corresponding hypothesis is to be measured by the UE while each bit with a value of “0” may indicate a corresponding hypothesis is not to be measured by the UE. In such a case, gNB may indicate more than one hypotheses to be measured by the UE.

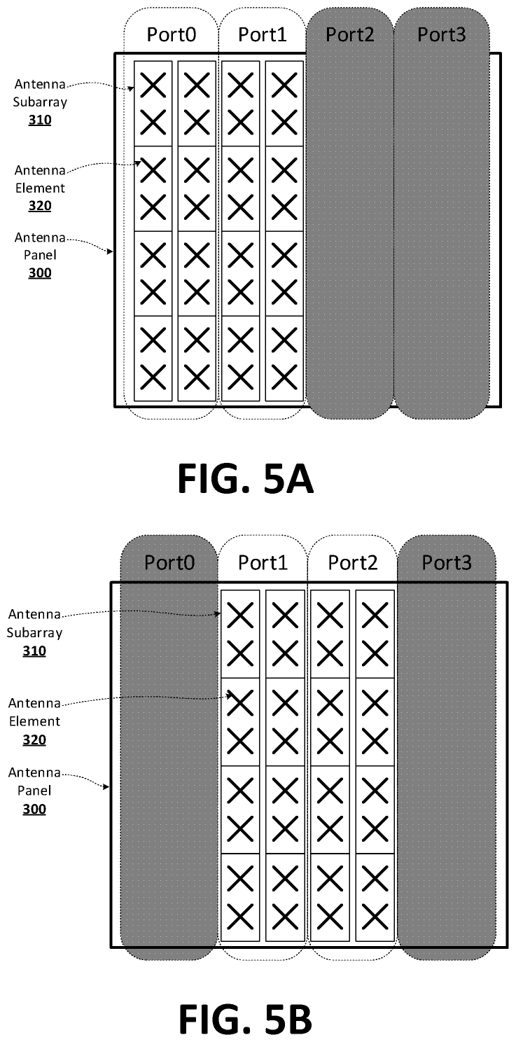

FIG. 5A and FIG. 5B are diagrams illustrating exemplary antenna panels with different subsets of RS ports selected by the UE according to an embodiment of the present disclosure.

When the Table 2 is defined or configured at UE and gNB sends, to UE, the MAC CE shown in (a) of FIG. 4 and DCI having the bitfield “00”, UE may determine that the CSI ports 0 and 1 shall be measured and reported while the CSI ports 2 and 3 shall not be measured and reported as if they are muted (they need not to be actually muted), as shown in FIG. 5A. For another example, when the Table 2 is defined or configured at UE and gNB sends, to UE, the MAC CE shown in (a) of FIG. 4 and DCI having the bitfield “01”, UE may determine that the CSI ports 1 and 2 shall be measured and reported while the CSI ports 0 and 3 shall not be measured and reported as if they are muted, as shown in FIG. 5B.

With this method, gNB can quickly know the predicted performance for different combinations of antenna muting.

Further, when a same MAC/CE and/or a same DCI (e.g., a group common DCI) are received by multiple UEs, each of the UEs may interpret the MAC/CE and/or DCI in its own way. For example, with different tables of hypotheses defined/configured, a UE with Table 2 configured may determine different CSI-RS ports to measure than those determined by another UE with Table 3 defined. For another example, when a same table is configured at multiple UEs and a group common DCI is received by the multiple UEs, they can still determine different CSI-RS ports to measure, for example, due to different MAC CEs were received by the multiple UEs or different mappings from DCI bitfield values to subset indicated by MAC CE are applied at the multiple UEs.

Further, although the table/MAC CE/DCI are described in the above embodiments as being associated with a specific CSI-RS configuration or resources indicated by the specific CSI-RS configuration, the present disclosure is not limited thereto. In some other embodiments, the table/MAC CE/DCI may be defined for more than one CSI-RS configuration. In such a case, even if the table/MAC CE/DCI are same for multiple UEs, the UEs may measure different CSI-RS ports mapped to different frequency/time resources, respectively.

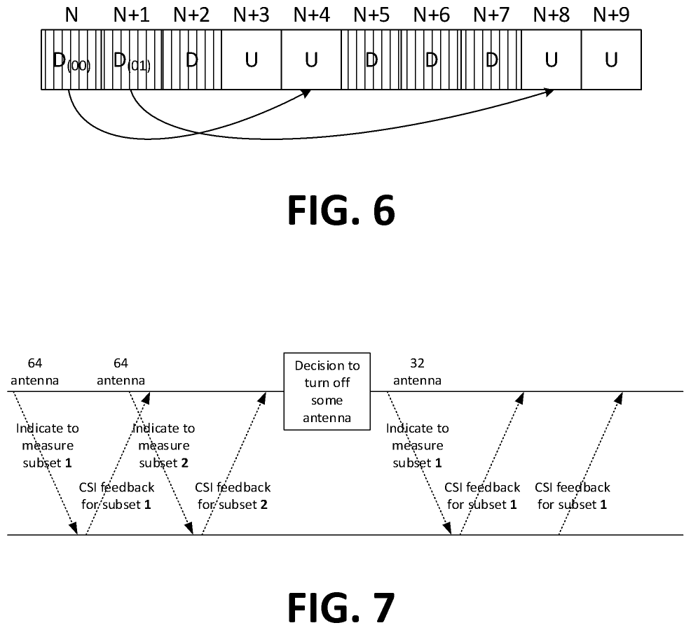

FIG. 6 is a diagram illustrating an exemplary dynamic change between different subsets of RS ports according to an embodiment of the present disclosure. A block with “D” refers to a slot, at least a part (symbol) of which may be used for downlink transmission. Further, a block with “U” refers to a slot, at least a part (symbol) of which may be used for uplink transmission.

As shown in FIG. 6 at slot N, a DCI may indicate UE to measure according to hypothesis index 4 (e.g., with the bitfield set to “00”), and at slot N+1, a DCI may indicate UE to measure according to hypothesis index 7 (e.g., with the bitfield set to “01”). During this period, as there is no actual antenna muting, the change from one hypothesis to another can be very fast. Once the gNB has acquired measurements for various hypotheses, it can decide which transceivers are optimal or suitable enough for communication with the UE and based on the results choose to utilize energy saving states on the other transceiver chains. For example, if the UE reports good enough channel state estimates on index 7 at slot N+8, the gNB could maintain the data channels (e.g., PDSCH) on transceivers associated to Ports 1 and 2. The gNB can now choose to not transmit data (PDSCH) on Ports 0 and 3. As a result, less energy is used by the gNB.

In some embodiments, the maximum size of the DCI bitfield used for this feature may be defined, e.g., a maximum of 2, 3, 4 bits, etc. This maximum size may additionally depend on the number of the configured ports. For example, for a UE with a configured port of 2 and 4, the maximum size of the antenna-muting bitfield may be 2 and 4 bits, respectively. The maximum number of hypotheses may then depend on this maximum bitfield size.

In some embodiments, the MAC CE signaling may be used to fully define the subset of hypotheses to be reported, without the need for an additional indication in the DCI. This may limit the specification impact to MAC CE only, without requiring new DCI format or bit interpretation definitions.

In some embodiments, the active port subset may be indicated using a bit map, using e.g., 4 bit positions in the above example, where each bit position indicates whether the corresponding port is active. The hypothesis value may then be directly the value corresponding to the bitmap. In that embodiment, no prior definition of CSI-RS port combinations, e.g., via SI or via RRC, is required.

In some embodiments, the actual bit size may also depend on the number of hypotheses actually configured for the UE. For example, if the UE is configured with 4 ports, but the gNB only configures with 8 hypotheses, the bitfield size may be 3 bits instead of 4 bits. In some embodiments, the bit size can also be configured explicitly with higher layer signaling.

In some embodiments, a minimum time gap between the slot containing the DCI indicating the CSI-RS measurement and the slot containing the CSI-RS may be defined. In one example, this may be done by setting a restriction. For example, when this feature is configured for a UE, the UE must be configured with aperiodicTriggeringOffset with a value greater than a certain threshold, e.g., greater than 0. In another example, a minimum gap may also be configured, e.g., in the RRC, by which the UE knows that the values of the aperiodicTriggeringOffset will be equal to or greater than the configured minimum gap. This minimum gap can be a new defined parameter or can be derived from, e.g., Rel. 16 minimumSchedulingOffsetKO parameter.

In some embodiments, the DCI may be an existing scheduling DCI which is used to trigger a CSI report, e.g., DCI 1_1 and/or DCI 1_2. In another embodiment, it can be a new DCI format specifically designed to indicate NW energy saving measures to a UE, or a group common DCI. The latter is particularly useful when the intention is to trigger some or all of the UEs within a cell to report the measurements of a hypothesis. In this case, in one approach, all the UEs can report their CSI measurements at the same time, but maybe in different frequency resources, or alternatively, the UEs can be divided into one or more groups and each group receives its own resources where it can report the measurement results.

In some embodiments, the UE may be configured with a periodic or semi-persistent CSI report, and in this case, MAC CE can again be used to enable a set of hypotheses, and then the associated DCI can be applied to determine the hypothesis that the UE should consider for a specific CSI-RS resource in one or more of the upcoming CSI report occasions. In one example of this embodiment, the DCI may indicate a first hypothesis associated with a first CSI-RS resource, a second hypothesis associated with a second CSI-RS resource, and so on. The second CSI-RS resource can be the same as the first one just transmitted at a different time.

In some embodiments, the UE may generate the CSI-RS report format to match the hypothesis currently in effect. This may lead to a highest signaling efficiency when the UE's interpretation of the current hypothesis matches the transmission and configuration pattern used by the gNB. In case of missing or erroneously receiving DCI-based hypothesis change indication, the reporting format may be illegible to the gNB, or it may be misinterpreted. In some embodiments, the UE may perform all reporting according to the maximum configured number of ports but report a zero value or another predetermined value for inactive ports, i.e., ports that it did not measure.

In some embodiments, an alternative misalignment mitigation measure on the gNB side may be to interpret the current report according to a report format corresponding to the previous hypothesis if its format was incompatible with the current expected reporting configuration and/or retransmit the current hypothesis configuration command.

With the CSI reports for different hypotheses, gNB may know which hypothesis can provide the best performance that can fit the needs for traffic demand, and therefore can make antenna muting decision. In some embodiments, a message then may be sent from gNB to UE to tell UE that it shall measure according to this CSI-RS port configuration from now on which may correspond to the actual antenna muting. Then UE can report CSI report periodically without further triggering messages. This is illustrated in FIG. 7.

FIG. 7 is a diagram illustrating an exemplary scenario in which subsets of CSI-RS ports to be measured and/or reported are indicated by the gNB before and after antenna muting is performed according to an embodiment of the present disclosure. As shown in FIG. 7, a gNB with 64 antenna elements activated may request the UE to perform partial measurements for CSI-RS ports, for example, by a method described above. For example, the gNB may instruct the UE to measure a subset 1 of CSI-RS ports and report its measurement and then may instruct the UE to measure a subset 2 of CSI-RS ports and report its measurement, as shown in FIG. 7. Once both of the measurements are obtained, the gNB may determine to turn off some antenna elements based on the measurements. For example, the gNB may turn off antenna elements associated with the CSI-RS ports with a lower performance (e.g., a lower RSRP, a higher noise, etc.). As a specific example, 32 antenna elements associate with the subset 2 are turned off by gNB as shown in FIG. 7. After that, as indicted by the gNB, the UE may periodically measure the subset 1 and periodically report its measurements, without any further signaling/trigger required.

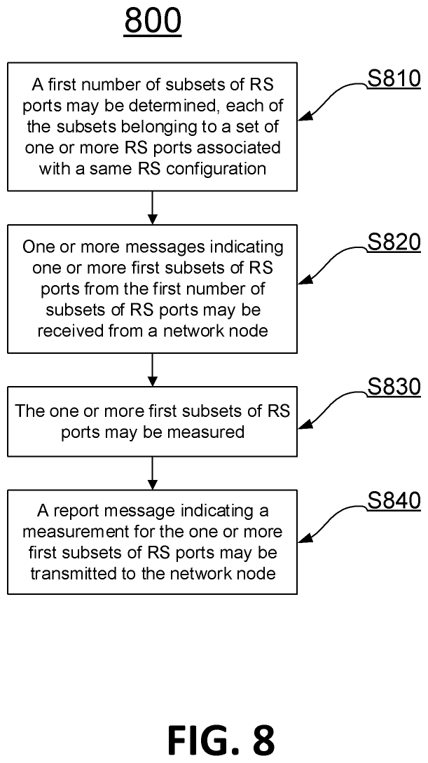

FIG. 8 is a flow chart of an exemplary method 800 at a UE for reporting a measurement for one or more RS ports according to an embodiment of the present disclosure. The method 800 may be performed at a user equipment (e.g., the UE 100). The method 800 may comprise step S810, S820, S830, and S840. However, the present disclosure is not limited thereto. In some other embodiments, the method 800 may comprise more steps, less steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where a first number of subsets of RS ports may be determined, each of the subsets belonging to a set of one or more RS ports associated with a same RS configuration.

At step S820, one or more messages indicating one or more first subsets of RS ports from the first number of subsets of RS ports may be received from a network node.

At step S830, the one or more first subsets of RS ports may be measured.

At step S840, a report message indicating a measurement for the one or more first subsets of RS ports may be transmitted to the network node.

In some embodiments, the step of determining the first number of subsets of RS ports may comprise at least one of: receiving, from the network node, a first message indicating the first number of subsets of RS ports; and determining the first number of subsets or RS ports based on a local configuration that is preconfigured or hard-coded at the UE. In some embodiments, at least one of the first message and the one or more messages may be received via at least one of: RRC signaling dedicated to the UE; SI broadcasted by the network node; MAC CE; and DCI.

In some embodiments, the one or more messages may comprise at least one of: a second message indicating a second number of subsets of RS ports comprising the one or more first subsets, each of the second number of subsets belonging to the set of one or more RS ports associated with the same RS configuration; a second message indicating a single subset of RS ports; a third message indicating a third number of subsets of RS ports comprising the one or more first subsets, each of the third number of subsets belonging to the set of one or more RS ports associated with the same RS configuration; a third message indicating a single subset; and a fourth message requesting the UE to report a measurement for RS ports without specifying which subset of RS ports to be measured. In some embodiments, at least one of following may be true: the second message indicates one or more of the first number of subsets as the single subset or the second number of subsets; the third message indicates one or more of the first number of subsets as the single subset or the third number of subsets; and the third message indicates one or more of the second number of subsets as the single subset or the third number of subsets when the second message is also received.

In some embodiments, at least one of following may be true: the first message is received via RRC signaling or SI broadcasted by the network node; the second message is received via MAC CE; the second message is received via DCI while the third message is not received; and the third message is received via DCI. In some embodiments, a DCI, via which one of the one or more messages is received, may comprise a bitfield indicating which one or ones of the one or more subsets are to be measured. In some embodiments, at least one of following may be true: each value of the bitfield indicates a corresponding first subset is to be measured; and each bit in the bitfield indicates whether a corresponding first subset is to be measured or not.

In some embodiments, a MAC CE, via which one of the one or more messages is received, may comprise a bitfield indicating a part of the first number of subsets as the second number of subsets, and each bit in the bitfield may indicate whether a corresponding one of the first number of subsets is indicated as one of the second number of subsets or not. In some embodiments, when the first message is received via SI broadcasted by the network node, the second message and/or the third message may be a group common DCI that is transmitted from the network node to a group of UEs comprising the UE. In some embodiments, the step of transmitting the report message may comprise: transmitting, to the network node, the report message over a first frequency resource that is different from a second frequency resource used by another UE in the group of UEs for transmitting its report message.

In some embodiments, the step of determining the one or more first subsets of RS ports may comprise at least one of: determining the single subset or the third number of subsets indicated by the third message as the one or more first subsets when the third message is received; determining the single subset or the second number of subsets indicated by the second message as the one or more first subsets when the third message is not received and the second message is received; and determining the first number of subsets indicated by the first message as the one or more first subsets when neither the third message nor the second message is received and the first message is received.

In some embodiments, the step of transmitting the report message may comprise at least one of: transmitting, to the network node, the report message at a report timing that is determined based on a reception timing at which one of the messages is received and a relationship between the report timing and the reception timing indicated by at least one of the one or more messages; transmitting, to the network node, the report message at a report timing that is determined based on a reception timing at which one of the messages is received and a preconfigured or hardcoded relationship between the report timing and the reception timing; and transmitting, to the network node, the report message further indicating one or more identifiers identifying the one or more first subsets that are actually measured. In some embodiments, the relationship may be indicated by a DCI message.

In some embodiments, a number of bits in a bitfield of a DCI message for indicating a first subset of RS ports may depend on at least one of: a number of RS ports configured at the UE; a number of subsets of RS ports, that are configured by the network node for the UE and belong to a set of one or more RS ports associated with a same RS configuration; and higher layer signaling. In some embodiments, a minimum time gap between a slot containing a DCI triggering a measurement of a RS port and a slot containing the RS port may be defined at the UE. In some embodiments, when the one or more messages comprises a DCI, the DCI may be one of: DCI format 1_1; DCI format 1_2; a group common DCI; and a DCI format that is different from any DCI format defined in 3GPP TS 36.212, V17.0.0, 3GPP TS 38.212 v17.0.0, and/or any of their previous releases.

In some embodiments, the method 800 may further comprise: determining one or more second subsets of RS ports at least based on at least one of the first message, the one or more messages and another local configuration, each of the second subsets belonging to a set of one or more RS ports associated with another RS configuration; measuring the one or more second subsets of RS ports; and transmitting, to the network node, another report message indicating a measurement for the one or more second subsets of RS ports. In some embodiments, the report message may have at least one of: a format that matches the one or more first subsets; and a format that matches the set of one or more RS ports associated with the same RS configuration, wherein the report message may indicate a predetermined value for any RS port that is comprised in the set but not comprised in the one or more first subsets. In some embodiments, the method 800 may further comprise: receiving, from the network node, a fifth message indicating a determined subset of RS ports that belongs to the set of one or more RS ports associated with the same RS configuration; and periodically measuring the determined subset of RS ports and periodically transmitting, to the network node, a report message indicating a measurement for the determined subsets of RS ports. In some embodiments, the determined subset of RS ports may correspond to an antenna muting pattern that is applied at the network node.

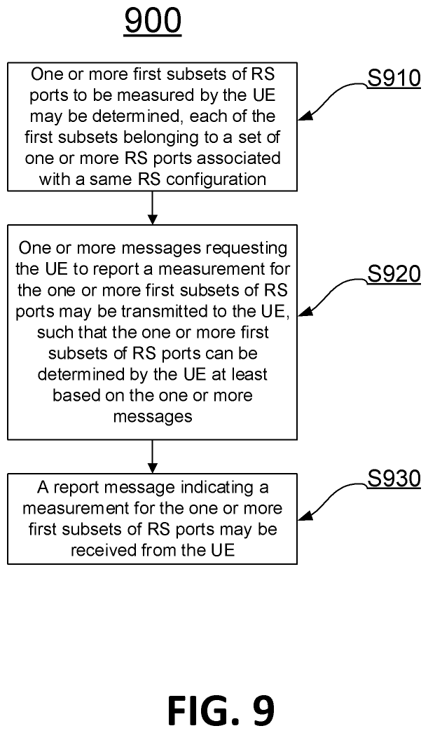

FIG. 9 is a flow chart of an exemplary method 900 at a network node for facilitating a UE in reporting a measurement for one or more RS ports according to an embodiment of the present disclosure. The method 900 may be performed at a network node (e.g., the gNB 105). The method 900 may comprise steps S910, S920, and S930. However, the present disclosure is not limited thereto. In some other embodiments, the method 900 may comprise more steps, less steps, different steps, or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910 where one or more first subsets of RS ports to be measured by the UE may be determined, each of the first subsets belonging to a set of one or more RS ports associated with a same RS configuration.

At step S920, one or more messages requesting the UE to report a measurement for the one or more first subsets of RS ports may be transmitted to the UE, such that the one or more first subsets of RS ports can be determined by the UE at least based on the one or more messages.

At step S930, a report message indicating a measurement for the one or more first subsets of RS ports may be received from the UE.

In some embodiments, at least one of the one or more messages may be transmitted via at least one of: RRC signaling dedicated to the UE; SI broadcasted by the network node; MAC CE; and DCI. In some embodiments, the one or more messages may comprise at least one of: a first message indicating a first number of subsets of RS ports comprising the one or more first subsets, each of the first number of subsets belonging to the set of one or more RS ports associated with the same RS configuration; a second message indicating a second number of subsets of RS ports comprising the one or more first subsets, each of the second number of subsets belonging to the set of one or more RS ports associated with the same RS configuration; a second message indicating a single subset of RS ports; a third message indicating a third number of subsets of RS ports comprising the one or more first subsets, each of the third number of subsets belonging to the set of one or more RS ports associated with the same RS configuration; a third message indicating a single subset; and a fourth message requesting the UE to report a measurement for RS ports without specifying which subset of RS ports to be measured. In some embodiments, at least one of following may be true: the second message indicates one or more of the first number of subsets as the single subset or the second number of subsets when the first message is also transmitted; the third message indicates one or more of the first number of subsets as the single subset or the third number of subsets when the first message is also transmitted; and the third message indicates one or more of the second number of subsets as the single subset or the third number of subsets when the second message is also transmitted.

In some embodiments, at least one of following may be true: the first message is transmitted via RRC signaling or SI broadcasted by the network node; the second message is transmitted via MAC CE; the second message is transmitted via DCI while the third message is not transmitted; and the third message is transmitted via DCI.

In some embodiments, a DCI, via which one of the one or more messages is transmitted, may comprise a bitfield indicating which one or ones of the one or more subsets are to be measured. In some embodiments, at least one of following may be true: each value of the bitfield indicates a corresponding first subset is to be measured; and each bit in the bitfield indicates whether a corresponding first subset is to be measured or not. In some embodiments, a MAC CE, via which one of the one or more messages is transmitted, may comprise a bitfield indicating a part of the first number of subsets as the second number of subsets, and each bit in the bitfield may indicate whether a corresponding one of the first number of subsets is indicated as one of the second number of subsets or not. In some embodiments, when the first message is transmitted via SI broadcasted by the network node, the second message and/or the third message may be a group common DCI that is transmitted from the network node to a group of UEs comprising the UE. In some embodiments, the step of receiving the report message may comprise: receiving, from the UE, the report message over a first frequency resource that is different from a second frequency resource used by the network node for receiving another report message from another UE in the group of UEs.

In some embodiments, the step of receiving the report message may comprise at least one of: receiving, from the UE, the report message at a report timing that is determined based on a reception timing at which one of the messages is received by the UE and a relationship between the report timing and the reception timing indicated by at least one of the one or more messages; receiving, from the UE, the report message at a report timing that is determined based on a reception timing at which one of the messages is received by the UE and a preconfigured or hardcoded relationship between the report timing and the reception timing; and receiving, from the UE, the report message further indicating one or more identifiers identifying the one or more first subsets that are actually measured. In some embodiments, the relationship may be indicated by a DCI message.

In some embodiments, a number of bits in a bitfield of a DCI message for indicating a first subset of RS ports may depend on at least one of: a number of RS ports configured at the UE; a number of subsets of RS ports, that are configured by the network node for the UE and belong to a set of one or more RS ports associated with a same RS configuration; and higher layer signaling. In some embodiments, a minimum time gap between a slot containing a DCI triggering a measurement of a RS port and a slot containing the RS port may be defined at the network node. In some embodiments, when the one or more messages comprises a DCI, the DCI may be one of: DCI format 1_1; DCI format 1_2; a group common DCI; and a DCI format that is different from any DCI format defined in 3GPP TS 36.212, V17.0.0, 3GPP TS 38.212 v17.0.0, and/or any of their previous releases.

In some embodiments, before the step of transmitting the one or more messages, the method 900 may further comprise: determining one or more second subsets of RS ports to be measured by the UE, each of the second subsets belonging to a set of one or more RS ports associated with another RS configuration; and wherein after the step of transmitting the one or more messages, the method 900 may further comprise: receiving, from the UE, another report message indicating a measurement for the one or more second subsets of RS ports. In some embodiments, the report message may have at least one of: a format that matches the one or more first subsets; and a format that matches the set of one or more RS ports associated with the same RS configuration, wherein the report message may indicate a predetermined value for any RS port that is comprised in the set but not comprised in the one or more first subsets.

In some embodiments, one or more RS ports that are not comprised in the one or more first subsets may be not muted when the UE is measuring the one or more first subsets. In some embodiments, the method 900 may further comprise: determining which one or ones of the set of RS ports are to be muted at least based on the report message; and muting the determined one or more RS ports. In some embodiments, the method 900 may further comprise at least one of: decoding the report message according to a report format used in decoding the previous report message in response to determining that the report message cannot be decoded correctly; and retransmitting, to the UE, at least one of the one or more messages to request the UE perform the measurement or report the measurement again. In some embodiments, the method 900 may further comprise: determining a subset of RS ports to be periodically measured and periodically reported by the UE at least based on the measurement for the one or more first subsets of RS ports, the determined subset of RS ports belonging to the set of one or more RS ports associated with the same RS configuration; transmitting, to the UE, a fifth message indicating the determined subset of RS ports; and periodically receiving, from the UE, a report message indicating a measurement for the determined subsets of RS ports. In some embodiments, the determined subset of RS ports may correspond to an antenna muting pattern that is applied at the network node. In some embodiments, the fifth message may be transmitted via at least one of: RRC signaling dedicated to the UE; SI broadcasted by the network node; MAC CE; and DCI.

In some embodiments, the one or more RS ports may be CSI-RS ports. In some embodiments, at least one of the one or more subsets of RS ports may correspond to an antenna muting pattern at the network node. In some embodiments, the same RS configuration may be a configuration indicating an NZP CSI-RS resource.

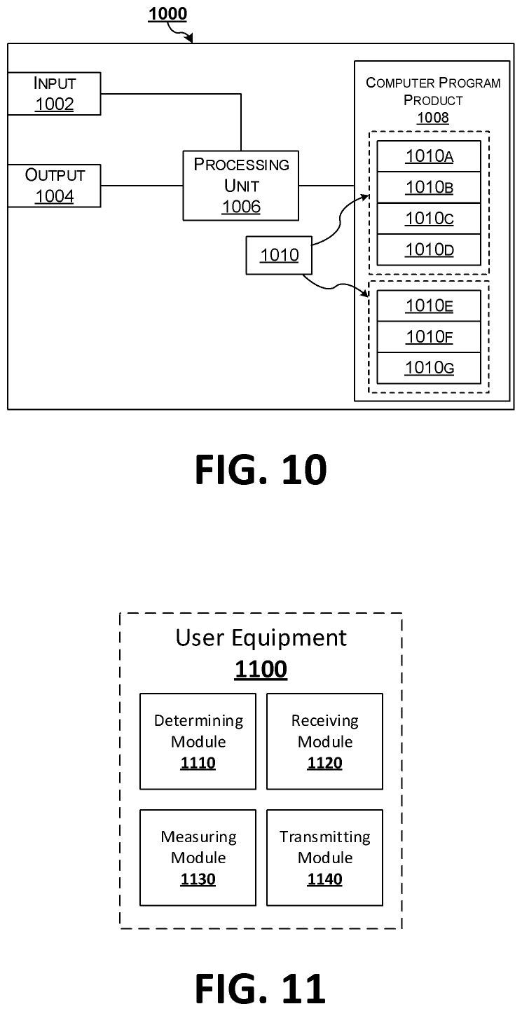

FIG. 10 schematically shows an embodiment of an arrangement 1000 which may be used in a user equipment (e.g., the UE 100) or a network node (e.g., the gNB 105) according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000 and/or the UE/network node in which it is comprised to perform the actions, e.g., of the procedure described earlier in conjunction with FIG. 1 to FIG. 9 or any other variant.

The computer program 1010 may be configured as a computer program code structured in computer program modules 1010A, 1010B, 1010C, and 1010D. Hence, in an exemplifying embodiment when the arrangement 1000 is used in a UE, the code in the computer program of the arrangement 1000 includes: a module 1010A configured to determine a first number of subsets of RS ports, each of the subsets belonging to a set of one or more RS ports associated with a same RS configuration; a module 1010B configured to receive, from a network node, one or more messages indicating one or more first subsets of RS ports from the first number of subsets of RS ports; a module 1010C configured to measure the one or more first subsets of RS ports; and a module 1010D configured to transmit, to the network node, a report message indicating a measurement for the one or more first subsets of RS ports.

Additionally or alternatively, the computer program 1010 may be configured as a computer program code structured in computer program modules 1010E, 1010F, and 1010G. Hence, in an exemplifying embodiment when the arrangement 1000 is used in a network node, the code in the computer program of the arrangement 1000 includes: a module 1010E configured to determine one or more first subsets of RS ports to be measured by the UE, each of the first subsets belonging to a set of one or more RS ports associated with a same RS configuration; a module 1010F configured to transmit, to the UE, one or more messages requesting the UE to report a measurement for the one or more first subsets of RS ports, such that the one or more first subsets of RS ports can be determined by the UE at least based on the one or more messages; and a module 1010G configured to receive, from the UE, a report message indicating a measurement for the one or more first subsets of RS ports.

The computer program modules could essentially perform the actions of the flow illustrated in FIG. 1 to FIG. 9, to emulate the UE or the network node. In other words, when the different computer program modules are executed in the processing unit 1006, they may correspond to different modules in the UE or the network node.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

Correspondingly to the method 800 as described above, an exemplary user equipment is provided. FIG. 11 is a block diagram of a UE 1100 according to an embodiment of the present disclosure. The UE 1100 may be, e.g., the UE 100 in some embodiments.

The UE 1100 may be configured to perform the method 800 as described above in connection with FIG. 8. As shown in FIG. 11, the UE 1100 may comprise a determining module 1110 configured to determine a first number of subsets of RS ports, each of the subsets belonging to a set of one or more RS ports associated with a same RS configuration; a receiving module 1120 configured to receive, from a network node, one or more messages indicating one or more first subsets of RS ports from the first number of subsets of RS ports; a measuring module 1130 configured to measure the one or more first subsets of RS ports; and a transmitting module 1140 configured to transmit, to the network node, a report message indicating a measurement for the one or more first subsets of RS ports.

The above modules 1110, 1120, 1130 and/or 1140 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the UE 1100 may comprise one or more further modules, each of which may perform any of the steps of the method 800 described with reference to FIG. 8.

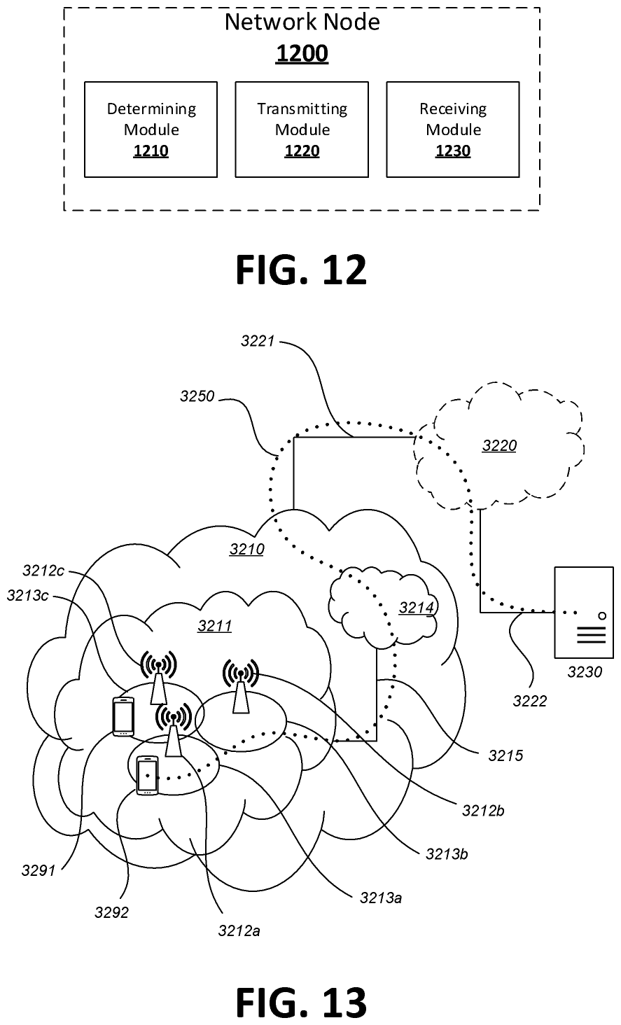

Correspondingly to the method 900 as described above, a network node is provided. FIG. 12 is a block diagram of an exemplary network node 1200 according to an embodiment of the present disclosure. The network node 1200 may be, e.g., the gNB 105 in some embodiments.

The network node 1200 may be configured to perform the method 900 as described above in connection with FIG. 9. As shown in FIG. 12, the network node 1200 may comprise a determining module 1210 configured to determine one or more first subsets of RS ports to be measured by the UE, each of the first subsets belonging to a set of one or more RS ports associated with a same RS configuration; a transmitting module 1220 configured to transmit, to the UE, one or more messages requesting the UE to report a measurement for the one or more first subsets of RS ports, such that the one or more first subsets of RS ports can be determined by the UE at least based on the one or more messages; and a receiving module 1230 configured to receive, from the UE, a report message indicating a measurement for the one or more first subsets of RS ports.

The above modules 1210, 1220, and/or 1230 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 9. Further, the network node 1200 may comprise one or more further modules, each of which may perform any of the steps of the method 900 described with reference to FIG. 9.

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

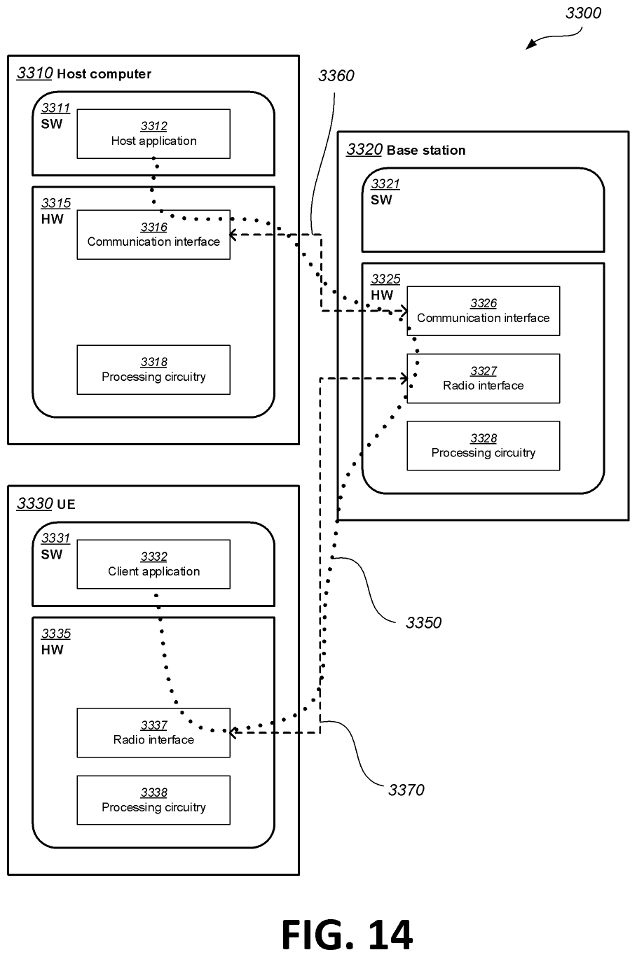

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

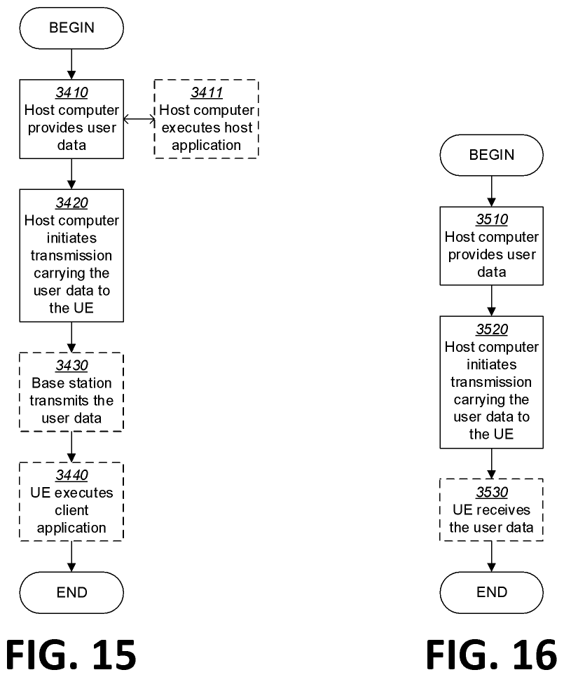

FIG. 15 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

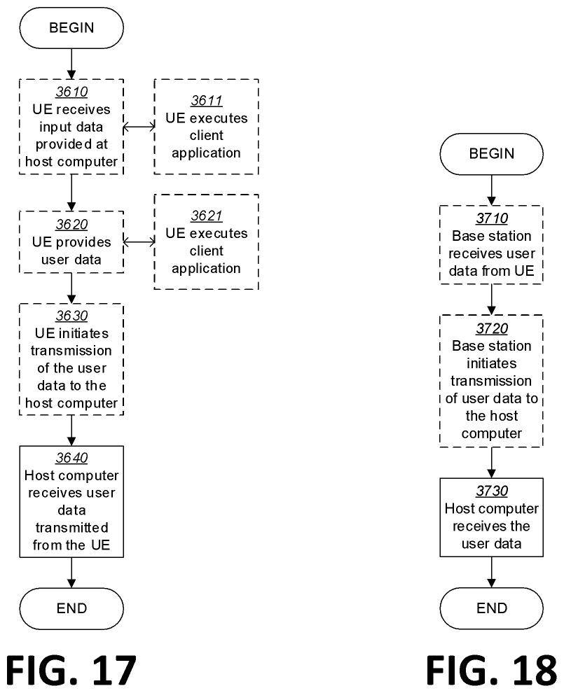

FIG. 17 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1.-56. (canceled)

57. A method at a User Equipment (UE) for reporting a measurement for one or more reference signal (RS) ports, the method comprising:
determining a first number of subsets of RS ports, each of the subsets belonging to a set of one or more RS ports associated with a same RS configuration;
receiving, from a network node, one or more messages indicating one or more first subsets of RS ports from the first number of subsets of RS ports;
measuring the one or more first subsets of RS ports; and
transmitting, to the network node, a report message indicating a measurement for the one or more first subsets of RS ports.

58. The method of claim 57, wherein the step of determining the first number of subsets of RS ports comprises at least one of:
receiving, from the network node, a first message indicating the first number of subsets of RS ports; and
determining the first number of subsets or RS ports based on a local configuration that is preconfigured or hard-coded at the UE.

59. The method of claim 57, wherein at least one of the first message and the one or more messages is received via at least one of:
Radio Resource Control (RRC) signaling dedicated to the UE;
System Information (SI) broadcasted by the network node;
Medium Access Control (MAC) Control Element (CE); and
Downlink Control Information (DCI).

60. The method of claim 57, wherein the one or more messages comprise at least one of:
a second message indicating a second number of subsets of RS ports comprising the one or more first subsets, each of the second number of subsets belonging to the set of one or more RS ports associated with the same RS configuration;
a second message indicating a single subset of RS ports;
a third message indicating a third number of subsets of RS ports comprising the one or more first subsets, each of the third number of subsets belonging to the set of one or more RS ports associated with the same RS configuration;
a third message indicating a single subset; and
a fourth message requesting the UE to report a measurement for RS ports without specifying which subset of RS ports to be measured.

61. The method of claim 60, wherein at least one of following is true:
the second message indicates one or more of the first number of subsets as the single subset or the second number of subsets;
the third message indicates one or more of the first number of subsets as the single subset or the third number of subsets; and
the third message indicates one or more of the second number of subsets as the single subset or the third number of subsets when the second message is also received.

62. The method of claim 58, wherein at least one of following is true:
the first message is received via RRC signaling or SI broadcasted by the network node;
the second message is received via MAC CE;
the second message is received via DCI while the third message is not received; and
the third message is received via DCI.

63. The method of claim 59, wherein a DCI, via which one of the one or more messages is received, comprises a bitfield indicating which one or ones of the one or more subsets are to be measured; wherein each value of the bitfield indicates a corresponding first subset is to be measured; and
each bit in the bitfield indicates whether a corresponding first subset is to be measured or not.

64. The method of claim 57 wherein a MAC CE, via which one of the one or more messages is received, comprises a bitfield indicating a part of the first number of subsets as the second number of subsets, and each bit in the bitfield indicates whether a corresponding one of the first number of subsets is indicated as one of the second number of subsets or not.

65. The method of claim 60, wherein when the first message is received via SI broadcasted by the network node, the second message and/or the third message are a group common DCI that is transmitted from the network node to a group of UEs comprising the UE; wherein the step of transmitting the report message comprises:
transmitting, to the network node, the report message over a first frequency resource that is different from a second frequency resource used by another UE in the group of UEs for transmitting its report message.

66. The method of claim 60, wherein the step of determining the one or more first subsets of RS ports comprises at least one of:
determining the single subset or the third number of subsets indicated by the third message as the one or more first subsets when the third message is received;
determining the single subset or the second number of subsets indicated by the second message as the one or more first subsets when the third message is not received and the second message is received; and
determining the first number of subsets indicated by the first message as the one or more first subsets when neither the third message nor the second message is received and the first message is received.

67. The method of any of claim 57, wherein the step of transmitting the report message comprises at least one of:
transmitting, to the network node, the report message at a report timing that is determined based on a reception timing at which one of the messages is received and a relationship between the report timing and the reception timing indicated by at least one of the one or more messages;
transmitting, to the network node, the report message at a report timing that is determined based on a reception timing at which one of the messages is received and a preconfigured or hardcoded relationship between the report timing and the reception timing; and
transmitting, to the network node, the report message further indicating one or more identifiers identifying the one or more first subsets that are actually measured; wherein the relationship is indicated by a DCI message.

68. The method of claim 57, wherein a number of bits in a bitfield of a DCI message for indicating a first subset of RS ports depends on at least one of:
a number of RS ports configured at the UE;
a number of subsets of RS ports, that are configured by the network node for the UE and belong to a set of one or more RS ports associated with a same RS configuration; and
higher layer signaling.

69. The method of claim 57, wherein a minimum time gap between a slot containing a DCI triggering a measurement of a RS port and a slot containing the RS port is defined at the UE.

70. The method of claim 57, further comprising:
determining one or more second subsets of RS ports at least based on at least one of the first message, the one or more messages and another local configuration, each of the second subsets belonging to a set of one or more RS ports associated with another RS configuration;
measuring the one or more second subsets of RS ports; and
transmitting, to the network node, another report message indicating a measurement for the one or more second subsets of RS ports.

71. The method of claim 57, wherein the report message has at least one of:
a format that matches the one or more first subsets; and
a format that matches the set of one or more RS ports associated with the same RS configuration, wherein the report message indicates a predetermined value for any RS port that is comprised in the set but not comprised in the one or more first subsets.

72. The method of claim 57, further comprising:
receiving, from the network node, a fifth message indicating a determined subset of RS ports that belongs to the set of one or more RS ports associated with the same RS configuration; and
periodically measuring the determined subset of RS ports and periodically transmitting, to the network node, a report message indicating a measurement for the determined subsets of RS ports, wherein the determined subset of RS ports corresponds to an antenna muting pattern that is applied at the network node; wherein the fifth message is received via at least one of:
RRC signaling dedicated to the UE;
SI broadcasted by the network node;
MAC CE; and
DCI.

73. The method of claim 57, wherein the one or more RS ports are Channel State Information Reference Signal (CSI-RS) ports;
at least one of the one or more subsets of RS ports corresponds to an antenna muting pattern at the network node; and/or the same RS configuration is a configuration indicating a None-Zero-Power (NZP) CSI-RS resource.

74. A user equipment (UE), comprising:
a processor;
a memory storing instructions which, when executed by the processor, cause the processor to perform:
determine a first number of subsets of RS ports, each of the subsets belonging to a set of one or more RS ports associated with a same RS configuration;
receive, from a network node, one or more messages indicating one or more first subsets of RS ports from the first number of subsets of RS ports;
measure the one or more first subsets of RS ports; and
transmit, to the network node, a report message indicating a measurement for the one or more first subsets of RS ports.

75. A method at a network node for facilitating a UE in reporting a measurement for one or more RS ports, the method comprising:
determining one or more first subsets of RS ports to be measured by the UE, each of the first subsets belonging to a set of one or more RS ports associated with a same RS configuration;
transmitting, to the UE, one or more messages requesting the UE to report a measurement for the one or more first subsets of RS ports, such that the one or more first subsets of RS ports can be determined by the UE at least based on the one or more messages; and
receiving, from the UE, a report message indicating a measurement for the one or more first subsets of RS ports.

76. The method of claim 75, wherein at least one of the one or more messages is transmitted via at least one of:
RRC signaling dedicated to the UE;
SI broadcasted by the network node;
MAC CE; and
DCI.
